(19) United States
(12) Patent Application Publication
(10) Pub. No.: US 2022/0237550 A1
(43) Pub. Date: Jul. 28, 2022

(54) ENTERPRISE LEGAL PLATFORM BACKED BY CUSTOM TABLES INTEGRATED INTO A DATA LAKE

(71) Applicant: UNITEDLEX CORP., Overland Park, KS (US)

(72) Inventors: Sean Daniel Jennings, Potomac, MD (US); Viren Umesh Bhakta, San Antonio, TX (US); Keara Elizabeth Fallon, San Francisco, CA (US); Timothy Daniel Igoe, Naples, NY (US); Megan Morris Ramsey, Atlanta, GA (US); Michael Odell Schoneman, Shawnee, KS (US); Jason William Wilcynski, Chicago, IL (US)

(21) Appl. No.: 17/579,960

(22) Filed: Jan. 20, 2022

Related U.S. Application Data
(60) Provisional application No. 63/140,422, filed on Jan. 22, 2021.

(51) Int. Cl. G06Q 10/06; G06Q 10/10; G06F 3/0482; G06F 16/25

(52) U.S. Cl. CPC G06Q 10/063114; G06Q 10/103; G06F 16/25; G06F 3/0482; G06Q 10/06316

(57) ABSTRACT

A system for managing data for diverse legal projects. The system comprises a project creation user interface that is configured to receive data defining a legal project by a legal discipline and a project type. The system includes a data lake that is configured to store unstructured data and structured data. The structured data is in the form of relational tables that are specifically configured for a respective one of a plurality of legal disciplines and project types. A new relational table is instantiated upon creation of the legal project in the project creation user interface. The relational table is configured specifically for the legal project based on the legal discipline and the project type. The unstructured data is in a form of documents associated with the legal project.

### CROSS-REFERENCE TO RELATED APPLICATIONS

This application claims priority to the provisional application U.S. 63/140,422 filed on Jan. 22, 2021, titled METHOD OF WORKFLOW MANAGEMENT AND SYSTEM THEREOF, and expressly incorporates the contents thereof in its entirety.

### DESCRIPTION OF THE RELATED TECHNOLOGY

Many organizations include multiple platforms for workflow management, such as accepting requests, reviewing the requests, or using a dashboard display for each professional in the organization. Communication between the multiple platforms is critical; however, the communication can be prone to synchronization errors or can include a lag. Further, the professionals of the organizations have to switch between multiple platforms for an end-to-end workflow or project management. Also, there are limited ways to track productivity across departments of the same organization efficiently. Further, the departments across the organization are fragmented and work in silos that resulting in a lack of transparency across the departments.

### SUMMARY

According to at least one example, the present disclosure discloses a system and a method for managing data for diverse legal projects. The system comprises a project creation user interface that is configured to receive data defining a legal project by a legal discipline and a project type. The project creation user interface is a structured form including a plurality of fields such as fields defining the legal discipline and the project type. A subset of the plurality of fields has a dependency relationship, wherein an option chosen in a first of the subset of the plurality of fields can cause fields in a second of the subset of the plurality of fields to dynamically populate with options that are dependent on the option chosen in the first of subset of fields.

The system further comprises a data lake configured to store unstructured and structured data. The structured data is in a form of relational tables specifically configured for a respective one of a plurality of legal disciplines and project types. A new relational table can be instantiated upon the creation of the legal project in the project creation user interface. The relational table is configured specifically for the legal project based on the legal discipline and the project type. The relational table is configured specifically for the legal project based on the options chosen in the plurality of the fields. The relational tables are configured to track progress towards milestones of the legal project. The milestones of the legal project are predefined based on the legal discipline and the project type. The unstructured data is in a form of documents that are associated with the legal project.

The system further comprises a workflow interface. The workflow interface is configured to allow the assignment of tasks associated with the legal project and to permit the acceptance of assigned tasks associated with the legal project. The workflow interface is automatically populated with tasks associated with milestones of the legal project. The workflow interface is configured to provide an interface to track progress towards completing the tasks. The interface tracks details of progress towards completion of the tasks and is populated with data stored in the data lake. The workflow interface is configured to manage any type of legal project supported by the system for managing data for diverse legal projects, and the workflow interface is configured to provide data to the data lake and to retrieve data from the data lake. The workflow interface is configured to link to an integrated legal work application for the performance of the task. The integrated legal work application is configured to report data to the data lake.

The system further comprises a reporting interface that is configured to pull data from the data lake to provide a report. The reporting interface is configured to provide an aggregated report that provides an aggregation of metrics that are in common across a plurality of projects in a plurality of legal disciplines. The reporting interface is also configured to provide an aggregated report that provides an aggregation of metrics across a plurality of projects in a legal discipline. Further, the system comprises an integration layer. The integration layer is configured to receive data from an enterprise system of a client and to ingest it into the data lake.

### BRIEF DESCRIPTION OF THE DRAWINGS

FIG. 1 illustrates an example system for managing data for diverse legal projects in accordance with some embodiments of the present disclosure.

FIG. 2 illustrates a legalflow system of an enterprise legal platform in accordance with some embodiments of the present disclosure.

FIG. 3 illustrates an insights system of the enterprise legal platform in accordance with some embodiments of the present disclosure.

FIG. 4 is an exemplary embodiment of a workspace interface of a primary portal in accordance with some embodiments of the present disclosure.

FIG. 5 is an exemplary embodiment of a service request interface in accordance with some embodiments of the present disclosure.

FIG. 6 is an exemplary embodiment of a project creation user interface in accordance with some embodiments of the present disclosure.

FIG. 7 is an exemplary embodiment of a workflow dashboard in accordance with some embodiments of the present disclosure.

FIG. 8 is an exemplary embodiment of a workflow interface in accordance with some embodiments of the present disclosure.

FIGS. 9A and 9B illustrate a reporting interface for providing visualizations corresponding to a plurality of diverse legal projects in accordance with some embodiments of the present disclosure.

FIG. 10 illustrates a drill-in interface for providing a summary of one or more service requests in accordance with some embodiments of the present disclosure.

FIG. 11 illustrates an example method for creating diverse legal projects in the enterprise legal platform in accordance with some embodiments of the present disclosure.

FIG. 12 illustrates an example method for managing diverse legal projects in the enterprise legal platform in accordance with some embodiments of the present disclosure.

FIG. 13 illustrates an example method for reporting data from the plurality of diverse legal projects in accordance with some embodiments of the present disclosure.

FIG. 14 shows an example of a computing system in accordance with some embodiments of the present disclosure.

### DETAILED DESCRIPTION

The following detailed description is presented to enable any person skilled in the art to make and use the inventive concept. For purposes of explanation, specific embodiments are provided only as representative examples. Various modifications to different embodiments will be readily apparent to one skilled in the art, and the general principles defined herein may be applied to other embodiments and applications without departing from the scope of the invention. The description is not intended to be limited to the embodiments shown but is to be accorded the widest possible scope consistent with the principles and features disclosed herein.

There is a need for a system or a method that allows functions or departments of the organization to be exposed to one or more projects or processes of the other functions or departments of the organization. Further, there is a need for a system or a method for providing a platform that acts as an interface and supports communication between core processes, legal components or corresponding portals, and business entities or corresponding portals of the organization. The core processes are functions or departments of the organization that are enabled by the integration of technology. The core processes may include contract lifecycle management, e-billing, outside council management, and the like. The legal component or the legal portal is supported by resources such as digital learning, workspace, and the like, that the functions or departments of the organization can access. The business component or the corresponding portal, that is, a primary portal, provides solutions to at least internal business clients. The primary portal may include self-service forms, chatbot resolution, client microsites, and the like. Furthermore, there is a need for a system or a method for providing a platform that supports end-to-end workflow or project management and tracks productivity across departments of the same organization for professionals of the organization without a necessity to switch between multiple platforms for the end-to-end workflow or project management.

The present disclosure includes a system and a method for managing data for diverse legal projects. The system and the method are directed to provide a platform for workflow management in an organization, the platform accepts and parses service requests that define a legal project by a legal discipline and a project type. The platform includes one or more interfaces, such as a project creation user interface, for one or more functions related to the management of one or more service requests. The platform may use artificial intelligence or machine learning on the parsed service requests to determine the requirements of the service request. The platform is coupled to a data lake configured to store unstructured and structured data. The structured data is in the form of relational tables and a new relational table can be instantiated upon the creation of the legal project in the project creation user interface. The unstructured data is in a form of one or more documents associated with the legal project. Further, the platform supports the assignment of the service requests to suitable professionals in the organization. In an embodiment, the one or more documents include files that are related to the legal project, which are, for example, disclosure materials for a patent, a product catalog to which a contract might pertain, evidence through discovery for a litigation, or the like. In another embodiment, the one or more documents include a legal work product which is a document that is result of performance of the legal project. For example, the legal work product includes a patent application, a contract, a litigation brief, or the like. The platform provides analytical information to a requester based on permission granted to the requester.

The platform is a window into the workflow management of an organization and provides a one-stop solution to initiate service requests across multiple departments of the organization, view statuses of the service requests, and escalate in case the statuses do not match predefined parameter(s) as laid out in service level agreements. Productivity and efficiency are discernible metrics in legal services which can be tracked with ease using the platform. General counsels can utilize the platform to keep track of at least spendings on legal services and optimal allocation of projects or work across the departments of the organization and use such data for effective contribution in C-suite discussions.

One or more siloed legacy systems are connected to the platform that enable service requests to get routed to appropriate one or more professionals. Self-service interfaces can also be enabled to create artifacts that demonstrate performance either across multiple departments of the organization or service requests. Further, the platform enables seamless access to everyday workflow tools and integrates a variety of application programming interfaces (APIs) from a library of service tools to provide trackable status and insights. The APIs are software intermediaries that allow communication between the workflow tools or programs. The platform also mitigates the recreation of repetitive processes that can be templated and/or automated. Users of the platform can be different management levels of any organization or organizations using or providing legal services. The users may also be prospective clients intending to use the platform.

The platform improves visibility into real-time metrics for legal services and operations by providing reliable, actionable data to individuals, such as legal professionals, managers, and leaders. The platform coalesces around enterprise technology strategy by reducing reliance on internal custom software initiatives and supports in providing consistent, reliable customer reporting and technology credibility and prowess across strategic business units of an organization.

The platform provides an aggregation of enterprise data to create actionable insights and provide a key performance indicator scorecard to prioritize continuous improvement in high-impact focus areas. The platform also provides data corresponding to team utilization, efficiency, and performance analytics. The platform allows automated processes by supporting single source intake, request routing, and approval for workflows. The platform can also eliminate routine tasks through artificial intelligence enabled self-service and triage. The platform can aggregate data across business groups to create actionable and business-focused insights and can provide a central interface that integrates multiple departments and enterprise tools. The platform supports an optimized service delivery model. The optimized service delivery model comprises an optimized resource model enabling disaggregation of the work and efficient work allocation, liquid resource model for volume peaks and valleys, accelerated skills learning focused on domain expertise, operational excellence, and digital capabilities.

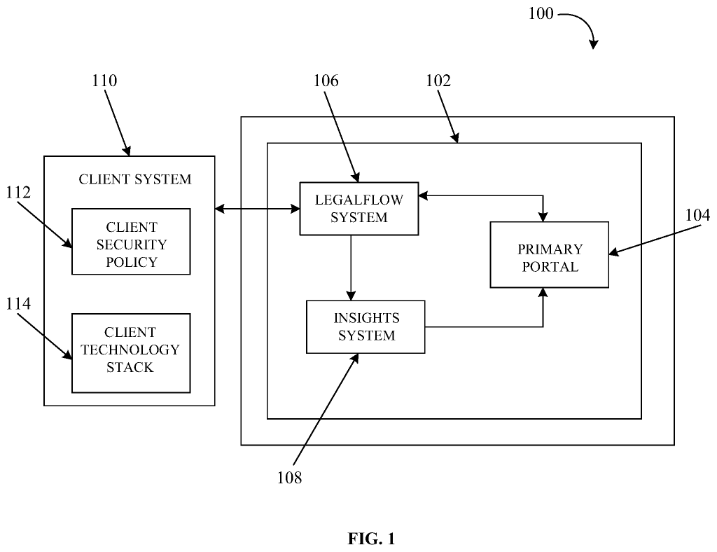

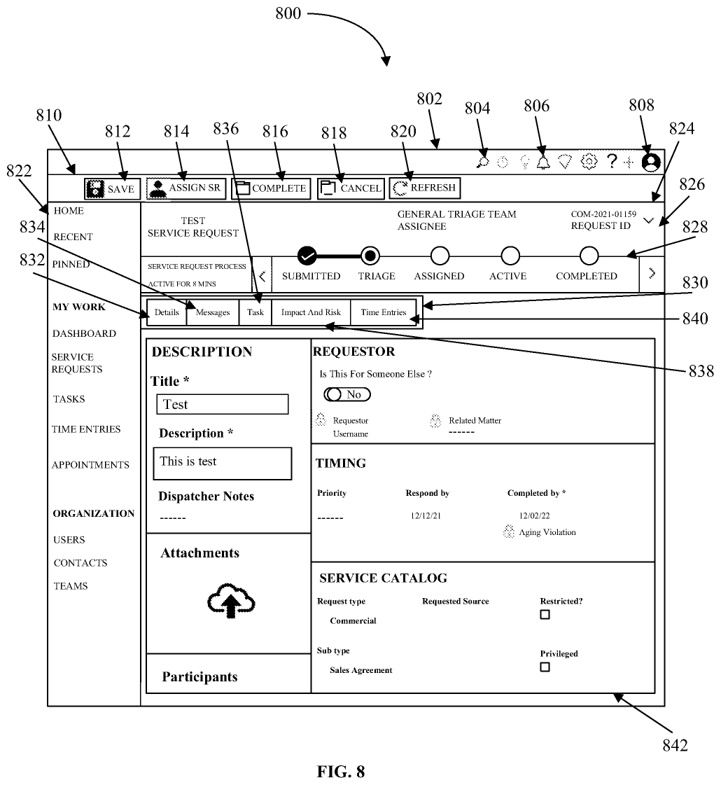

FIG. 1 illustrates an example system 100 for managing data for diverse legal projects. The system 100 includes at least an enterprise legal platform 102, also referred to as the platform 102, that communicates and/or exchanges data with a client system 110. The platform 102 includes a portal such as a primary portal 104 and sub-systems such as a legalflow system 106 and an insights system 108. The legalflow system 106 provides a workflow interface 800, illustrated in FIG. 8, that supports the assignment of tasks of a legal project or the legal project itself to a team or one or more legal professionals.

Further, the legalflow system 106 provides information regarding what one or more users are working on, where and how the work is being performed by the users and the importance of the work. The term “user” refers to individuals or organizations that use the platform 102. In an example, the user is a client or a client organization that uses the platform 102 for requesting services and viewing statuses related to one or more service requests or viewing statistics corresponding to different aspects or attributes of one or more legal projects. In an example, the users are one or more legal professionals or individuals that are associated with an organization that receives the service request from the client and works on the received service request. Further, the system 100 renders the information provided by the legalflow system 106 at the primary portal 104.

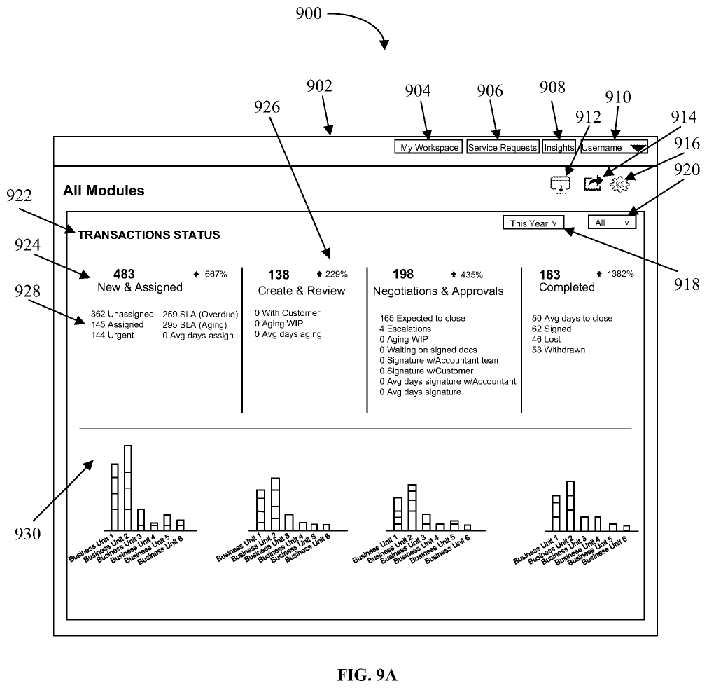

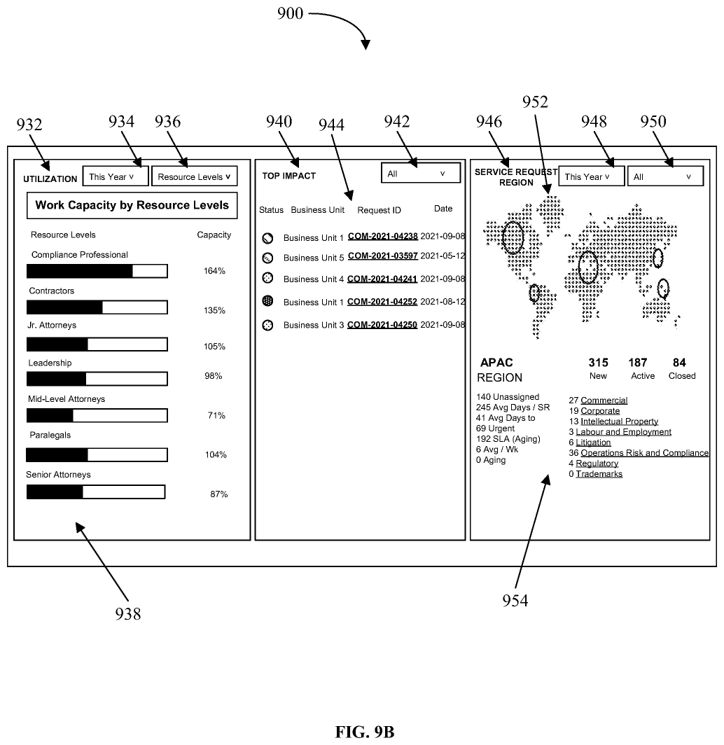

The insights system 108 provides a reporting interface 900, illustrated in FIGS. 9A and 9B, which renders and provides an aggregated report with an aggregation of metrics that are common across a plurality of projects in a plurality of legal disciplines. The term “legal disciplines” refers to legal departments of the organization. The insights system 108 also includes one or more dashboards with the information provided by the legalflow system 106. Further, the system 100 renders the information provided by the insights system 108 at the primary portal 104.

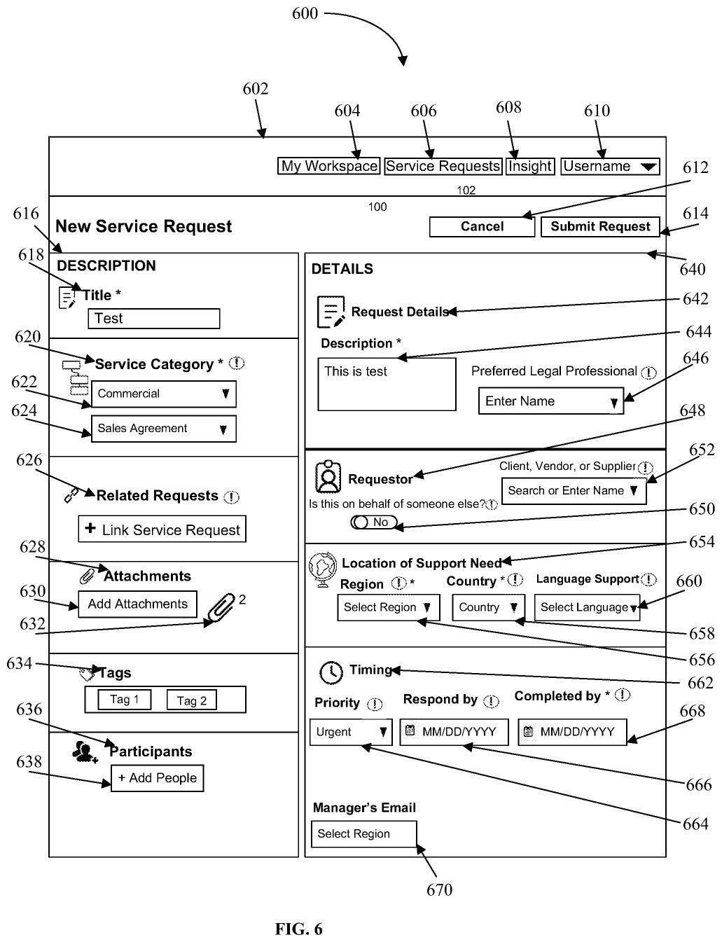

The primary portal 104 is accessible to the user upon successful user authentication and the primary portal 104 includes a project creation user interface 600, illustrated in FIG. 6, configured to receive data that defines a legal project by the legal discipline and a project type. The primary portal 104 includes one or more dashboards for presenting analytical information to the user. The primary portal 104 also includes links to access the interfaces such as the workflow interface 800 and the reporting interface 900.

The system 100 is communicatively coupled to the client system 110, also referred to as client environment 110 of the client organization. The client system 110 is an enterprise system of the client that comprises a security environment including a client security policy service 112 and a client technology stack 114. The client security policy service 112 supports a client authentication protocol, such as single sign-on (SSO), or Security Assertion Markup Language (SAML). The client technology stack 114 includes a combination of one or more tools or frameworks that support the overall functioning of the client system 110 or the client organization. The client technology stack 114 includes, for example, Human Resource Information System (HRIS), Customer Relationship Management (CRM), and the like. In an embodiment, the one or more tools of the client technology stack 114 are also data sources of the client system 110.

The platform 102 connects with the client system 110 through the client authentication protocol, that is the SSO, and mimics the security environment of the client system 110 for allowing the client to use the platform 102 as an extension. Upon successful authentication, the user logs in to the platform 102 through the SSO and accesses data corresponding to the work in the platform 102 from the client system 110. The user is directed to at least one of the primary portal 104 and one or more applications of the legalflow system 106. In an example, the one or more applications corresponds with analyzing a plurality of documents for categorizing one or more documents based on a classification input. In another example, the one or more applications corresponds with supporting various tools that may be built with different architectures or environments for the management of one or more received requests. The management of the one or more received requests includes troubleshooting upon receiving dissatisfactory results or outputs from one of the various tools. The platform 102 receives and provides data from and to the client technology stack 114, respectively, through an intermediary layer of the legalflow system 106.

The platform 102 is customizable based on the requirements of each client, thereby providing each client a customized environment within the platform 102. Further, the platform 102 also provides a framework or an environment that isolates client data and blocks unintentional external exposure of the client data to another client. In an embodiment, the platform 102 utilizes the Microsoft Azure® tenant to achieve the desired functionality.

The platform 102 tracks, records, and presents information to one or more users such as one or more legal departments or the client corresponding to the client system 110. The legal department, in an example, includes one or more legal professionals performing core work, one or more team leads reviewing the core work of the legal professionals, a general counsel, and senior leadership overlooking the work or projects of the one or more departments of the client organization. The platform 102 furnishes customized information to different users based on hierarchy or specialized permissions, and holistically provides an insight into the projects and processes across the one or more legal departments or within a specific team of the organization.

In an embodiment, the platform 102 provides predictive analysis rendering information corresponding to, for example, a forthcoming month, quarter, or year. The predictive analysis is based on the recorded information by the platform 102. The platform 102 employs an analytical or machine learning model for performing predictive analysis. The predictive analysis also supports prescriptive analysis for predicting results that shall be obtained by the user or the client organization based on one or more choices of the user or the client organization, without a necessity to create another architecture from scratch.

The platform 102, with the above-mentioned systems, automatically scales and adapts based on the requirements of the client. The platform 102 evolves based on the needs of the client and is capable of presenting customized multiple layers of analytics.

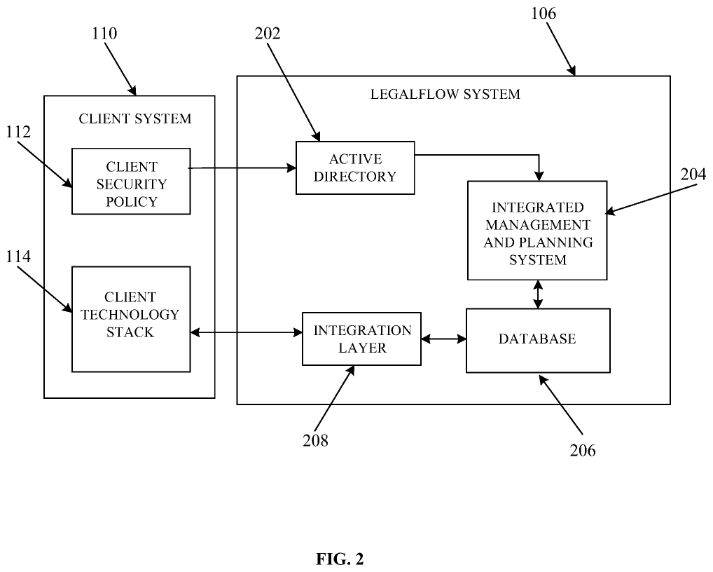

FIG. 2 illustrates the legalflow system 106 of the platform 102 that is described in conjunction with the description of FIG. 1. The legalflow system 106 includes an active directory 202, an Integrated Management and Planning System (IMPS) 204, a database 206, and an integration layer 208. The SSO in conjunction with the active directory 202 supports the users to sign in and access at least one of internal and external resources in multiple applications. In an embodiment, the active directory 202 includes the Azure® Active Directory® service. Upon successful authentication, the active directory 202 extends allowance of access of the user to the primary portal 104, as disclosed in FIG. 1, and the IMPS 204.

The IMPS 204 is a system with a combination of features of a Customer Relationship Management (CRM) system and an Enterprise Resource Planning (ERP) system. The IMPS 204 includes at least features and applications such as customer insights for providing analytics, visualizations, and the like, and human resources application for managing all areas of human resources (HR), from attracting, hiring, and onboarding new employees to managing HR programs. IMPS 204 supports event handling for one or more applications that correspond with the platform 102. In an embodiment, the IMPS 204 includes Microsoft Dynamics 365® to achieve the desired functionality.

The legalflow system 106 includes the database 206 coupled to other systems, such as insights system 108, or the primary portal 104. The system 100 facilitates the provision of a topographical view corresponding to multiple aspects of projects or discussions to different users of the client organization through custom entities of the database 206. The custom entities support the system 100 to provide data in the database 206 based on at least specialized permissions to the user, designation of the user, and the like, etc. The database 206 is synchronized with an underlying architecture corresponding to the legalflow system 106, for recording and archiving information of the users and the client organization. The underlying architecture supports synchronization between one or more sub-systems/portals of the system 100. The synchronization allows the system 100 to record one or more events or information in real-time, information about what tasks one or more users are working on, information corresponding to where the one or more users are working on the task, information regarding nature of the task, and information about stage/progress of the task. Both the legalflow system 106 and the system 100 record the synchronized information that supports in-depth analytics. Upon receiving a query, the systems, for example, the insights system 108 of the platform 102 disclosed in FIG. 1, parse the database 206 and provide one or more relevant results to the querying user. In an embodiment, the database 206 includes Azure® Dataverse.

The database 206 includes a series of tables or entities that record information of events in real-time through telemetry and is configured to store structured data. The structured data is in the form of relational tables and one or more relational tables are configured for each legal discipline and project type corresponding to the client organization. A new relational table can be instantiated upon the creation of the legal project in the project creation user interface, where the relational table is configured specifically for a legal project that is based on the legal discipline and the project type. The database 206 is also configured to store unstructured data that includes documents and legal work product associated with the legal project. The database 206 includes source information for classifying one or more activities in a service catalog corresponding to the legalflow system 106. Subsequently, the database 206 records the structured and unstructured data against the source information associated with classifying the one or more activities in the service catalog. Microsoft Dynamics 365® stores the service catalog as a configuration element. The database 206 stores one or more data tables and configuration selections associated with the service catalog.

The system 100 logs and stores each milestone and each action of the user towards completion of each milestone in the relational tables of the database 206. Each document corresponding to the action, the milestone, or the project on which the user is working, is stored in the database 206. In an exemplary embodiment, a user may begin working on a first project or a first task on a morning until the afternoon of the same day. The user may switch working on a second project or a second task from the afternoon till the end of the day. In such a scenario, the platform 102 tracks progress and time invested by the user on each of the projects. The tracking of the progress and the time of projects or tasks provides traceability that enables other users to determine the status of the project or the task with minimal to nil requirement of the user for knowledge transfer corresponding to the first or second projects or tasks.

The legalflow system 106, other systems, or the portals of the platform 102 access the data stored in the database 206 for processing and providing relevant information to the user.

Upon processing the accessed data, the platform 102 pushes the processed data from the database 206 to the client system 110 through the integration layer 208. The platform 102 also pulls data from the client system 110 to the database 206, through the integration layer 208, upon determining a necessity. The integration layer 208 is the intermediary layer between the legalflow system 106 and the client system 110. Specifically, the integration layer 208 is coupled to the client technology stack 114 for accessing or providing data. The integration layer 208 interfaces the client system 110 with the platform 102 and supports event handling and handles standard Application Programming Interfaces (APIs). In an embodiment, to realize the functionality of the integration layer 208, the platform 102 utilizes individual modules that function together.

The integration layer 208 manifests as public APIs that allow the users of the client system 110 to access the platform 102 and pull data from or push data to the legalflow system 106 based on a determination of one or more event triggers. The integration layer 208 also allows pulling data or pushing data from or to the client technology stack 114. The one or more event triggers include but are not limited to receiving input to view virtualizations, providing a document with the requested information, and the like. The primary portal 104, through the integration layer 208, performs one or more calls to a core infrastructure based upon the determination of the one or more event triggers for receiving or sending data to the client system 110. The core infrastructure refers to the database 206 and architecture of the insights system 108. Upon receiving an initiation, that is, a push or a pull event trigger, by the user, through the legalflow system 106, the database 206 logs data corresponding to the event trigger and stores the information that shall be pushed or pulled. Subsequently, the integration layer 208 translates the information that shall be pushed or pulled to or from the client system 110 respectively.

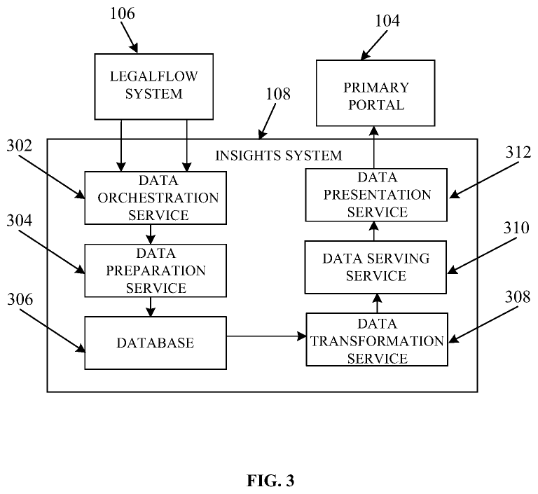

FIG. 3 illustrates the insights system 108 of the platform 102 that is described in conjunction with the description of FIGS. 1 and 2. The insights system 108 is communicatively coupled to the legalflow system 106 and the primary portal 104 for receiving data and providing visualizations corresponding to the received data. The insights system 108 includes a data orchestration service 302, a data preparation service 304, a database 306, a data transformation service 308, a data serving service 310, and a data presentation service 312.

The data orchestration service 302, also referred to as an ingestion service, is configured to access or pull data from one or more data sources such as the one or more tools of the client technology stack 114 through the integration layer 208, illustrated in FIG. 2. In an embodiment, the one or more data sources include at least one of cloud data sources, software as a service (SaaS) data source, and the database 306. Further, the insights system 108 receives data from the database 206 of the legalflow system 106 illustrated in FIG. 2. The database 206 provides data received from the one or more interfaces corresponding to the primary portal 104. In an embodiment, the database 306 includes Azure® Data Lake. The components “database 306” and the “database 206” can be interchangeably used for realizing one or more functions of the system 100.

The insights system 108 utilizes one or more tools for ingesting data from one or more internal and external sources. The one or more tools are dynamic and may function as virtual machines for the execution of the predetermined specific tasks and are built on demand. Further, the one or more tools include preset algorithms for executing predetermined specific tasks. In an embodiment, the tool for ingesting data includes Azure® Databricks. Further, the insights system 108 schedules the ingestion of the data from the one or more data sources by utilizing a tool or a scheduler that pulls data based on one or more predetermined scheduled times, that is, periodically, or based on one or more event triggers. The ingestion of data from multiple data sources is performed in parallel. In an example, the database 306 ingests structured data from the database 206 and integrates the ingested data with existing data, which supports the insights system 108 for providing in-depth and real-time analytics. In an embodiment, the insights system 108 utilizes Azure® Data Factory as a scheduler for supporting ingestion of the data from the one or more data sources. In an embodiment, the ingestion of data is performed sequentially.

Upon ingesting the data from the one or more data sources by the data orchestration service 302, the insights system 108 configures the data preparation service 304 to copy or duplicate the ingested data. In an embodiment, the data preparation service 304 duplicates the data from the one or more data sources of the client system 110, as illustrated in FIG. 1, in parallel to ingestion of the data by the data orchestration service 302 from another data source, such as the database 206. The data preparation service 304 provides the users, such as the legal professionals, the duplicated data for any usage or processing by the legal professionals. The provision of the duplicated data to the legal professionals allows the ingested data to be unaffected by any modifications from the legal professionals, thereby allowing the users or legal professionals to view the original version of the ingested data for reference or check.

Upon storing the duplicated data, the data preparation service 304 cleanses the duplicated data to eliminate or correct predefined errors, for example, null characters, line breaks, rouge commas, and the like, or modify the duplicated data to place it in a better form. The data preparation service 304, in an embodiment, cleanses the duplicated ingested data based on predefined rules. For example, a predefined rule may include the presentation of names of one or more countries in an unabbreviated form. Upon cleansing, the data preparation service 304 modifies the abbreviated form of names of the one or more countries to the unabbreviated form.

The insights system 108 utilizes one or more machine learning algorithms for optimizing the data orchestration service 302 and the data preparation service 304 for forthcoming iterations of configurations. The insights system 108 also utilizes the one or more machine learning algorithms for optimizing other services such as the data transformation service 308, the data serving service 310, and the data presentation service 312. In an embodiment, the data preparation service 304 utilizes tools, such as the Azure® Data Factory and the Azure® Databricks for the duplication of the ingested data, and the cleansing of duplicated data. The insights system 108 then stores the ingested data in the database 306, which is also referred to as the data lake 306. In an embodiment, the database 306 includes Azure® Data Lake, also referred to as the data lake 306, that utilizes a three-zone strategy.

The ingested data is positioned in a zone one of the data lake 306. The insights system 108 also stores the duplicated data, and the cleansed data in the zone one of the data lake 306. In an embodiment, the insights system 108 stores data from one or more services, such as 302, 304, 308, 310, and 312 to the database 306 in parallel.

The data orchestration service 302, upon ingestion of the data, stores the ingested data instantaneously in the data lake 306, and the data preparation service 304 uses the stored ingested data for duplication. Further, the data preparation service 304 cleanses the duplicated data is stored in the data lake 306. The cleansed data is stored in the data lake 306 and is used by the services such as 308, 310, and 312, of the insights system 108. The data preparation service 304 utilizes the tools, for example, the Azure® Data Factory and the Azure® Databricks, for preparing the cleansed and stored data for Extract, Transform, Load (ETL) process.

The data transformation service 308 performs the ETL process on the stored and cleansed data and prepares the stored and cleansed data for fact and dimensions table of Structured Query Language (SQL)®. The insights system 108 stores the ETL processed data in zone two of the data lake 306. The data transformation service 308 further performs versioning of the ETL processed data that allows the user to compare and contrast data between different versions. In an embodiment, the data transformation service 308 performs versioning by creating preset snapshots of the processed data.

The insights system 108 includes one or more service catalogs with multiple levels that correspond with different fields of one or more interfaces or the forms corresponding to the primary portal 104, the legalflow system 106, or the insights system 108. A service catalog, of the one or more service catalogs, includes an expandable list of fields of the one or more interfaces or forms, that are assigned a higher priority by the platform 102. The service catalog is typically created by an administrator or the one or more machine learning algorithms of the platform 102. The service catalog is created based on determining sets of events in one or more service request cases. The determined sets of events are used for creating one or more snapshots of data of the fields of the one or more interfaces or forms. The priorities to the one or more fields are assigned by the platform 102 based on the determined sets of events of the one or more service request cases corresponding to the client.

In an embodiment, the fields with the higher priority are the fields that a client intends to search or to access the most. Such high priority fields are learned by the one or more machine learning algorithms supporting the platform 102. In another embodiment, the fields with the higher priority are the fields that are related to predetermined key events corresponding to the client. The insights system 108 is configured to classify the interaction of the client with the one or more of the different fields or data with the higher priority, as an event trigger.

Upon receiving the event trigger, the insights system 108, particularly the data transformation service 308, creates the preset snapshots of the data of the one or more fields of the one or more interfaces or forms. The preset snapshots may include a combination of fields with different priorities. The data transformation service 308 may consider data of a subset of fields from multiple fields of the entire one or more interfaces or forms for creating preset snapshots, thereby eliminating the generation of excessive data during versioning that may not be required. For example, if the one or more interfaces or forms include data in hundred fields, then the data transformation service 308 creates a view of twelve fields based on the service catalog. Therefore, by considering a predetermined subset of fields based on the service catalog rather than the complete one or more interfaces or forms for creating the preset snapshots and storing versions of the one or more interfaces or forms, the storage requirements for the process of versioning are reduced.

Further, the subset of fields considered for the preset snapshots, in an embodiment, are related to a discrete task. For example, the discrete task includes receiving basic information related to a service request and the preset snapshots include a title field and a description field of a service request form. The service catalog directs the insights system 108 to consider data of different subsets of fields for different event triggers. The usage of the service catalog allows an administrator to add new service request cases without a necessity to recreate the platform 102, thereby supporting scalability of the platform 102 and which is further buildable based on the one or more machine learning algorithms.

The data transformation service 308 organizes or stores the preset snapshots of the data of the fields of the one or more interfaces or forms in the zone two of the data lake 306 based on one or more event triggers related to one or more interfaces or forms. In an embodiment, the insights system 108 indexes the data present in the data lake 306 and performs a search on smaller sections of the data lake 306 that correspond with specific event triggers, upon receiving a query. The specific event triggers of the one or more event triggers are related to the reporting interface 900, illustrated later in FIGS. 9A and 9B, of the insights system 108, a workflow interface 800, illustrated later in FIG. 8, of the legalflow system 106, or a project creation user interface 600, illustrated later in FIG. 6. The indexing of the data of the data lake 306 further supports the insights system 108 to identify relevant results. Therefore, organizing or structuring the versioned data in the data lake 306 allows the user to raise a query and receive required results without overwhelming the data lake 306 and allowing the data lake 306 to be performant.

It will be apparent to a person with ordinary skill in the art that the one or more machine learning algorithms are utilized by the platform 102 for refining and modifying the organization of the versioned data in the data lake 306, thereby optimizing the platform 102. Further, upon receiving a new event trigger from the client, the platform 102 adapts and self-trains itself to include the new event trigger in the service catalog for creating the snapshots.

In an embodiment, the data transformation service 308 utilizes tools, such as the Azure® Data Factory and the Azure® Data Bricks, also referred to as data bricks, for performing the ETL process on the prepared data and for versioning the ETL processed data. The usage of the data bricks for the data orchestration service 302, the data preparation service 304, and the data transformation service 308 allows the system 100 to spin up and spin down resources such as Azure® Data Factory, on demand, thereby optimizing the performance of the platform 102. As a result, compute power across the platform 102 reduces advantageously which translates to a reduction in overall cost corresponding to the functioning of the platform 102.

The data transformation service 308 pulls disparate fields together for versioning and serving the versioned data for SQL® facts and dimension tables to the data serving service 310. The data bricks populate the SQL® facts and dimension tables based on the versioned and ETL processed data, thereby providing a holistic view across those different versions, and accordingly presenting the differences seamlessly to the user. The data transformation service 308 stores the populated SQL® fact and dimension tables in the zone two of the data lake 306. The insights system 108, therefore, creates master data that translates back into the legalflow system 106 as well as into the reporting interface 900, illustrated later in FIGS. 9A and 9B.

Upon completing the versioning of the data, the data transformation service 308 provides the versioned data to the data serving service 310 for preparing the versioned data for presentation. The versioned data is provided to the SQL Server® by the data serving service 310. The SQL Server® is associated with a SQL data model that governs how the data, including the versioned data, is utilized. The SQL Server® includes a series of fact and dimension tables for providing congruity between presenting the versioned data on a visual layer, that is the reporting interface 900 and to the legalflow system 106. The data serving service 310 allows the SQL® fact and dimension tables to update analysis services data cubes of analysis services tool. The data serving service 310 stored the updated or populated analysis services data cubes is stored in a zone three of the data lake 306, which is served to a tool corresponding to the data presentation service 312. In an embodiment, the data serving service 310 utilizes tools, such as the Azure® Analysis Services as the analysis services tool. In an embodiment, the data serving service 310 is supported by the usage of Azure® Databricks of the data transformation service 308, in conjunction with SQL Server® and Azure® Analysis Services.

The data serving service 310 provides the updated analysis services data cubes to data analysis and report authoring tool of the data presentation service 312. The analysis services data cubes, also referred to as data cubes, provide minimized necessary data to the user. However, updating the data cubes requires the data serving service 310 to perform an inordinate amount of analysis and preparation. Further, the data provided on the data analysis and report authoring tool associated with the data presentation service 312 is in congruence with the data on the one or more interfaces or the forms of the platform 102. In an embodiment, the one or more interfaces include interfaces with virtualizations or virtual representations, such as dashboard interfaces. In an embodiment, the data analysis and report authoring tool is a Power Bi tool that utilizes data from the analysis services tool to optimize performance and Role Based Access Control (RBAC) for user and client specific data views.

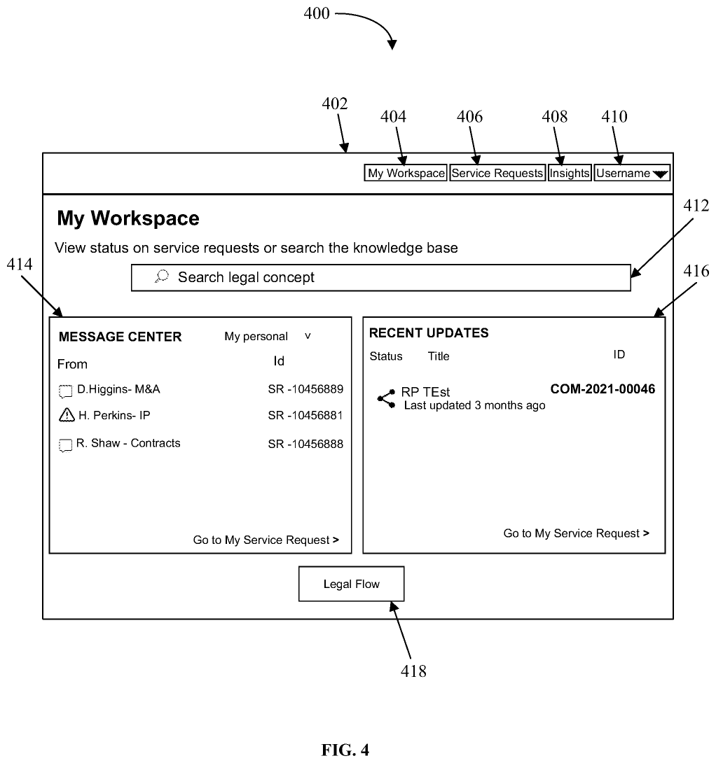

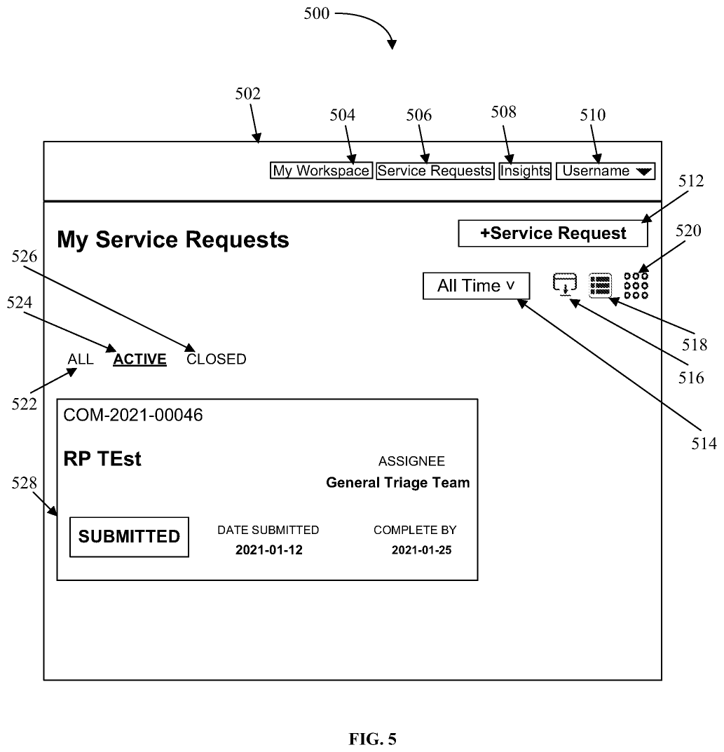

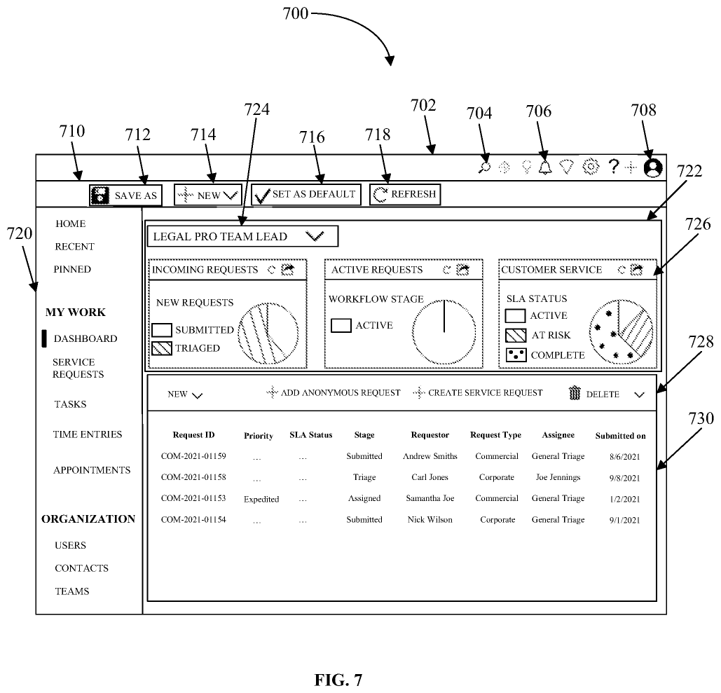

FIG. 4 is an exemplary embodiment of a workspace interface 400 of the primary portal 104. The primary portal 104 is provided to a user upon successful user authentication, as disclosed in the detailed description of FIG. 1. The term “user” for the workspace interface 400 refers to a client of a legal organization and also one or more professionals employed by or associated with the organization. The primary portal 104 provides the workspace interface 400 as a default interface upon successful authentication of the user. The workflow interface 400 includes a link panel 402 that includes a first link 404 to the workspace interface 400, a second link 406 to a service request interface 500, as illustrated in FIG. 5, and a third link 408 to the reporting interface 900, as illustrated later in FIGS. 9A and 9B. Further, the link panel 402 also displays a username of the authenticated user in a username information portion 410. The user may be able to sign out or change persona through the username information portion 410. The user may have multiple personas to choose from, based on a structure of the organization or based on specialized permissions. The workspace interface 400 also includes a fourth link 418 to a workflow dashboard 700, illustrated in FIG. 7.

The first link 404, the second link 406, the third link 408, and the fourth link 418 are links that direct the user to the corresponding interfaces, as mentioned above, upon receiving an input. For example, a click on the service request link i.e., the second link 406 directs the user to the service request interface 500. Similarly, a click on the first link 404 allows the user to return to the workspace interface 400. The primary portal 104 and the interfaces corresponding to the respective links 404, 406, 408, and 418 are communicatively coupled to the databases such as the database 206 and the data lake 306, as previously illustrated in FIGS. 2 and 3, respectively. The primary portal 104 and the interfaces corresponding to the respective links 404, 406, 408, and 418 are populated based on the information extracted from the databases. The databases, on the other hand, receive information from at least one of client system 110, legalflow system 106, and insights system 108, as illustrated in FIG. 1. Therefore, in an embodiment, the primary portal 104 and the interfaces corresponding to the respective links 404, 406, 408, and 418 provide real-time information to the user.

The workspace interface 400 further includes at least a search bar 412, a message overview portion 414, and a recent updates overview portion 416. The search bar 412 supports self-help for the user and receives inputs regarding one or more topics corresponding to legal concepts. The search bar 412 is communicatively coupled to a database or a knowledge base of the system 100, for example, the database 206, the data lake 306, or any external or internal databases. Upon receiving the user input, the system 100 provides relevant search results to the user. In an embodiment, the system 100 provides the search results in another interface. In an embodiment, the system 100 provides the search results in a pop-up window.

The recent updates overview portion 416 provides the overview of the service requests submitted by the user, such as a legal professional, working on the resolution of the service request. The recent updates overview portion 416 displays a summary of the one or more service requests by indicating the title, status, and a corresponding identifier (ID) of the one or more service requests. The summary of the one or more service requests is obtained from the databases of the platform 102, such as the database 206 and the data lake 306. In an embodiment, the recent updates overview portion 416 displays real-time information corresponding to the service request related to the user. At least one of the title and ID of the service requests are links and upon receiving an interactive input to the link, such as a click, the system 100 directs the user to an interface that provides in-depth information corresponding to the service request. In an embodiment, the workspace interface 400 includes a chat interface for communicating with individuals internal or external to the client organization.

The message overview portion 414 provides an overview of one or more messages to or from the user. In an embodiment, the message overview portion 414, customized for the user, such as the client, displays one or more messages related to the one or more service requests that the client has submitted. In an embodiment, the message overview portion 414, customized for the user, such as the legal professional working on the service requests, displays one or more messages from the client or other one or more legal professionals. The message overview portion 414 allows the user, such as the legal professional, to send messages to, read messages from, and respond to messages from at least one or more users or clients. Similarly, the message overview portion 414 allows the users, such as the client, to send messages to, read messages from, and respond to messages from at least one or more users or legal professionals.

The message overview portion 414 eliminates the necessity to switch to different platforms for reading, sending, or responding to one or more messages as the message overview portion 414 accumulates the messages corresponding to the service requests and displays the accumulated messages in the workspace interface 400 in a collated manner. Further, for ease of recognition of the origin of messages, the message overview portion 414 at least provides sender information corresponding to each of the one or more messages. The message overview portion 414 and the recent updates overview portion 416 include a link to the service request interface 500 (illustrated in FIG. 5) similar to the second link 406. Such a link is shown as “Go to My Service Request” is positioned at the bottom side of respective message overview portion 414 and the recent updates overview portion 416.

FIG. 5 is an exemplary embodiment of the service request interface 500 that displays each service request associated with the user and corresponding details, in a grid view. The term “user” for the service request interface 500 refers to the client of the legal organization who submits one or more service requests and also one or more legal professionals, who are employed by or associated with the organization working on one or more service requests. The service request interface 500 includes a link panel 502 with links and corresponding functionality similar to the link panel 402, illustrated in FIG. 4. A first link 504 and a second link 506 have a functionality similar to the first link 404 and second link 406, respectively, illustrated in FIG. 4. A third link 508 and a username information portion 510 have functionality similar to the third link 408 and the username information portion 410, respectively, illustrated in FIG. 4. For the sake of brevity, each of the elements 504, 506, 508, and 510 included in the link panel 502 are not described again.

The service request interface 500 includes a link or a trigger element such as a service request button 512 for directing the user to the project creation user interface 600, illustrated in FIG. 6. A time filter 514 allows the user to organize or filter the displayed one or more service requests along with the corresponding details based on one or more time-related parameters, such as a current month, a current year, a current quarter, and the like.

A download element 516 allows the user to download a summary of the one or more service requests that are being displayed on the service request interface 500. The user can modify the view of the service request interface 500 from the grid view to list one or more service requests associated with the user, that is a list view (not shown), by utilizing a list view element 518. In an embodiment, the service request interface 500 provides the list view, upon receiving a selection of the list view using the list view element 518. The list view of the service request interface 500 includes line items. Each of the line items provides a summary of a service request of the displayed one or more services. The list view, in an embodiment, also provides information related to priority and tags associated with the one or more service requests. The user can switch to the grid view using a grid view element 520.

The service request interface 500 includes one or more grids in the grid view. Each of the one or more grids provides a summary of a service request. For example, a grid 528 provides a summary of a service request and includes fields such as but not limited to title, status, request identifier, assignee, date submitted, and a complete by date for the service request. Further, the service request interface 500 allows the user to view the one or more grids based on the statuses of the service requests associated with the one or more grids. The user can view summaries of all the service requests associated with the user in the one or more grids using an “All” filter element 522. Further, the user can view summaries of only active or only closed service requests associated with the user in the one or more grids using an “Active” filter element 524 and a “Closed” filter element 526, respectively.

In an embodiment, the service request interface 500 also displays a timeline for each user desired service request. The timeline depicts one or more milestones and a current status of the desired service request. The service request interface 500 may also include a notification icon (not shown) that displays notifications regarding statuses of the one or more service requests and the one or more messages in, for example, a pop-up window, upon receiving an interactive input on the notification icon.

FIG. 6 is an exemplary embodiment of the project creation user interface 600 configured to receive data defining a legal project through multiple fields. The project creation user interface 600 provides a structured form, that is a service request form, for receiving data related to a service request from the user in an organized manner. The term “user” for the project creation user interface 600 refers to the client of the legal organization who intends to submit one or more service requests and also one or more legal professionals, who are employed by or associated with the organization.

The project creation user interface 600 includes a link panel 602 with links and corresponding functionality similar to the link panel 402, illustrated in FIG. 4. A first link 604 and a second link 606 have functionality similar to the first link 404 and the second link 406, respectively illustrated in FIG. 4. A third link 608 and a username information portion 610 have functionality similar to the third link 408 and the username information portion 410, respectively, illustrated in FIG. 4. For the sake of brevity, each of the elements 604, 606, 608, and 610 included in the link panel 602 are not described again. The legal project may be related but not limited to drafting a new contract, amending an existing contract, extracting features from a contract, conducting a patentability search, drafting a patent application, writing a technical analysis for an office action, conducting a trademark search, and the like. The multiple fields of the project creation user interface 600 are based on a service catalog that corresponds with generic sets of fields common across service requests with different legal disciplines and project types. In an embodiment, one or more fields of the multiple fields include default values. In an embodiment, one or more fields of the multiple fields are customized based on the user or client preferences.

The project creation user interface 600 includes a first form button 612 pointing to a cancel button 612, and a second form button 614 pointing to a submit request button 614. Upon receiving an input, for example, a click on the cancel button 612, the system 100 discards the current service request. Upon receiving an input, for example, a click on the submit button 614, the system 100 submits the service request form and the service request form is delivered to one of a professional or a server associated with processing the one or more service requests.

The project creation user interface 600 further includes a description portion 616 and a details portion 640, each comprising multiple fields for receiving inputs corresponding to the legal project from the user. The subsets of the multiple fields have a dependency relationship and an option chosen in a first subset of the multiple fields causes fields in a second subset of the multiple fields to dynamically populate with options that are dependent on the option chosen in the first subset of fields. The fields in the description portion 616 include fields such as a title field 618, a set of service category related fields 620, a related requests field 626, an attachment field 628, tags field 634, and participants field 636.

The title field 618 receives a title for the legal project from the user. The set of service category fields 620 includes a service request type field 622, which is a legal discipline field, and a sub type field 624, which is a project type field. The service request type field 622 receives input corresponding to the legal discipline that the legal project corresponds to. Upon receiving the input to the service request type field 622, the system 100 populates the sub type field 624 with options for the user to choose from. The options of the sub type field 624 are dependent on the option chosen in the service request type field 622. The options populated in the sub type field 624 corresponds to type of legal projects one or more legal professionals of the legal discipline work on. In an embodiment, the system 100 populates the options of the service request type field 622 and the sub type field 624 of the service category fields 620 based on a service catalog. The terms “service category fields 620” and the “service catalog” can be interchangeably used for realizing one or more functions of the system 100 within the scope of the present disclosure. Further, the terms “service request type field 622” and “sub type field 624” can be referred as “service category level 1” and “service category level 2” respectively.

For example, the user accesses the service request type field 622 and chooses “Commercial” as a legal discipline. The system 100 populates the sub type field 624 with various types of projects that correspond with the chosen legal discipline and the user chooses “Sales Agreement” amongst various options provided. In an embodiment, the system 100 provides one or more additional subset of fields based on the input to at least one of the service request type field 622 and the sub type field 624. The system 100 includes the service catalog for each option present in the service request type field 622 and each service catalog includes an expandable list of fields for the project creation user interface 600 or service request form.

The related requests field 626 allows the user to provide an input corresponding to one or more existing service requests from the client in scenarios when the user prefers to link the current service request with the existing requests. The attachment field 628 allows the user to upload one or more documents related to the service request. In an embodiment, the attachment field 628 includes an attachment interface button 630 that facilitates attachment of the one or more documents, upon receiving a click. In an embodiment, upon receiving a click on the attachment interface button 630, the system provides a window (not shown) that allows the user to drag and drop the one or more documents or add the one or more documents by surfing through one or more folders in a computing device of the user. Upon attaching the one or more documents, an icon 632 appears to indicate that the one or more documents are successfully attached. Upon hovering a cursor over the icon 632, a miniature window (not shown) pops up to display the details of the attachments that are, in an embodiment, stored in the data lake 306, disclosed in FIG. 3.

The tags field 634 receives one or more tag keyword inputs from the user, the tag keyword inputs correspond to system tags or arbitrary tags that support the user in organizing current service request among other service requests. In an embodiment, the one or more tag keyword inputs are visible exclusively to the user. The participants field 636 receives information corresponding to contacts of one or more individuals acting as watchers or collaborators for the service request. The participants field 636 includes an add participants button 638 that provides a directory (not shown) with contacts for selection, upon being clicked, and allows the user to choose one or more contacts from the directory. The selected contacts serve as watchers or collaborators for the service request.

The details portion 640 includes a set of request details field 642, a set of requestor information fields 648, a set of location of support need fields 654, a set of timing field 662, and a manager's email field 670. The set of request details field 642 includes a textbox 644 for receiving text input corresponding to the service request. The user may also request a specific legal professional for working on the service request by entering details corresponding to the preferred legal professional in a preferred legal professional field 646.

In an embodiment, the user requesting the service request may be a legal professional raising the service request on behalf of the client. For such a scenario, the project creation user interface 600 provides the set of requestor information fields 648 with an interface component 650, such as a toggle element 650, for indicating that the user is requesting the service on behalf of the client. Upon enabling the toggle element 650, the system 100 activates a dependent field 652, such as name of client field 652, for selecting at least name of the client represented by the user of the service request. In an embodiment, the user can select names of a vendor or a supplier through the name of client field 652. However, upon disabling the toggle element 650 by the user, the name of client field 652 is deactivated. In an embodiment, as a default option, the toggle element 650 is disabled and the name in the client field 652 is deactivated.

The set of location support need fields 654, also referred to as location fields 654, includes a region field 656, a country field 658, and a language support field 660 that are configured to receive inputs from the user corresponding to a preferred region, a preferred country, and a preferred language, respectively. Based on the inputs to the location fields 654, the system 100 directs the service request to the legal discipline or department that is present in the preferred region and country and that provides support in the preferred language.

The set of timing fields 662 receives input corresponding to one or more deadlines associated with the service request and priority of the service request. The set of timing fields 662 includes a priority field 664, a response timing field 666, and a completion timing field 668. The priority field 664 allows the user to provide an input related to the urgency of completion of work corresponding to the service request. The input to the priority field 664 may be one of standard priority and urgent priority.

The response timing field 666 receives a deadline for responding to the service request and the completion timing field 668 receives a deadline for completing tasks corresponding to the service request, from the user. In an embodiment, data of at least one of the response timing field 666 and the completion timing field 668 is predetermined if a service level agreement (SLA) exists between the client providing the service request and an organization that works on the service request. The SLA may include time parameters around service request response or service request completion, based on which the response timing field 666 or the completion timing field 668 is automatically populated. In an embodiment, the user selects the above-mentioned deadlines by picking dates from the calendar interface provided upon interacting with each of the fields of the above-mentioned deadlines. The manager's email field 670 receives an email address of an individual such as a manager of the user requesting the service, for providing information and/or communicating updates associated with the service request of the legal project.

In an embodiment, the system 100 automatically populates the project creation user interface 600 based on an email communication received from a client. The project creation user interface 600 prompts the user to provide information if one or more of the plurality of fields do not include data upon being automatically populated. In an embodiment, the system 100 considers at least one of email or a call from the client or a legal professional communicating on behalf of a client, as a service request.

The project creation user interface 600 is communicatively coupled to the data lake 306 illustrated in FIG. 3. The data lake 306 is configured to store the structured data which includes relational tables that are specifically configured for each of the options of the legal discipline, i.e., the service request type field 622 and the sub type field 624. The legal discipline is also referred to as a service category. Upon receiving a service request submission, the system 100 creates the legal project and instantiates a new relational table.

The new relational table is configured specifically for the legal project based on the legal discipline and the project type, and the new relational table collects data related to the legal project. Further, the new relational table is configured specifically for the legal project based on the options chosen in the plurality of the fields. The unstructured data such as the attachments which are in the form of documents, for example, attached through the attachment field 628, and legal work product associated with the legal project are stored in the data lake 306. The system 100 defines milestones for each legal project based on at least the chosen legal discipline or the project type. The new relational table is configured specifically for the legal project by including data structures to track progress towards the project milestones.

The system 100, in an embodiment, provides an uneditable version of the submitted service request form in a service request confirmation interface (not shown) to the request submitting user, upon receiving a successfully submitted service request form. Further, the system 100, in parallel, routes the received service request to a dispatcher for service request assignment or to a legal professional mentioned in the preferred legal professional field 646. In an embodiment, the submitted service request is directed to a service request pool, and the dispatcher considers each service request in the pool for assignment sequentially.

FIG. 7 is an exemplary embodiment of the workflow dashboard 700 provided to a user. The term “user” refers to a dispatcher associated with the organization that works on the service requests and also one or more legal professionals, who are employed by or associated with the organization. Upon successful authentication of the user, the system 100 renders the workflow dashboard 700 as a default interface. The workflow dashboard 700 includes a global ribbon bar 702, an interface management bar 710, a navigation panel 720, a visualization portion 722, a service request management strip 728, and a summary portion 730.

The user may be a dispatcher responsible for functions, which include reviewing the received service requests and assigning the received service requests to a relevant legal department or a legal professional of the client organization. The dispatcher analyzes, directs, and distributes the received submitted service requests. In an embodiment, the dispatcher is a human decision maker with an awareness corresponding to connections between departments of the organization or the resources for specific service requests. In another embodiment, the system 100 performs functions of the dispatcher in an automated manner without manual intervention.

The workflow dashboard 700 is communicatively coupled to one or more databases of the system 100, the one or more databases include database 206 illustrated in FIG. 2 and the data lake 306, illustrated in FIG. 3. The one or more databases of the system 100 stores data of the one or more submitted service requests. The system 100 parses the one or more databases and automatically populates the workflow dashboard 700. The global ribbon bar 702 includes at least a search icon 704 that allows the user to search at least a service request, one or more users, one or more teams, and the like, and a notification icon 706 that indicates the presence of one or more notifications to the user and allows the user to access the one or more notifications. Further, the global ribbon bar 702 includes a user profile icon 708 that provides information such as at least a username, designation, and other user related information.

The interface management bar 710 includes interface elements related to actions affecting the workflow dashboard 700 such as save a view 712, creation of a new service request 714, a default view setting 716, and refresh view 718. The interface management bar 710 is customized based on the user viewing the workflow dashboard 700. The save a view 712 allows a user to save an existing view of the workflow dashboard 700 in one or more memory elements of the system 100. The default view setting 716 allows the user to select the existing view of the workflow dashboard 700 as a default. The refresh view 718 allows the user to refresh the existing view of the workflow dashboard 700.

The navigation panel 720 includes multiple links that allow the user to access relevant information at least related to service requests, tasks, time entries, appointments, users, teams, contacts, and the like, and also indicates the current interface that the system 100 displays. The information accessed through the navigation panel 720 may be dependent on the persona or designation of the user. In an embodiment, upon receiving a click on a link in the navigation panel 720, the system 100 provides corresponding information in another interface.

The visualization portion 722 of the workflow dashboard 700 includes a persona selection element 724 and a representations portion 726. The persona selection element 724 allows the user to select a different persona that affects the contents of the representations portion 726 and the summary portion 730. For example, the user may have two designations and can choose a persona based on each designation. The user may have a designation as a legal professional team lead and a general counsel. The system 100 customizes the representations portion 726 and the summary portion 730 based on the chosen persona. In another example, the user may be the dispatcher and also a legal professional. The visualization portion 722 for the dispatcher may or may not be similar to the visualizations for the legal professional. The workflow dashboard 700 of the dispatcher may include summaries of all the service requests that were directed to the dispatcher for assignment. On the other hand, the workflow dashboard 700 of the legal professional may display details corresponding to a service request upon receiving an assignment from the dispatcher.

The representations portion 726 displays statistics or visualizations corresponding to the one or more attributes of the one or more service requests. For example, the representations portion 726 displays statistics using a pie chart related to each attribute of such incoming requests, active requests, customer service, customer urgency, and the like. It will be apparent to a person with ordinary skill in the art that the visualizations may include bar graph, line graph, histogram chart, scatter plot, or the like, for representing the attributes related to the service requests. In an embodiment, the representations portion 726 may provide more information related to the service requests in a pop-up window, upon detecting an interaction of the user with a visualization related to the service request. The user can interact with the one or more visualizations by hovering the cursor upon one or more visualizations of the representations portion 726. Each of the one or more visualizations in the representations portion 726 includes a refresh icon for refreshing the visualization and a share icon for sharing the visualization to one or more individuals. The one or more individuals are internal or external to an organization that receives or works on the service request.

The service request management strip 728 allows the dispatcher to at least create a new service request, create an anonymous service request, and delete one or more service requests displayed on the summary portion 730. The system 100 provides summarized information regarding each of the one or more service requests in the summary portion 730, thereby providing the dispatcher an overview of at least a real-time status of each of the one or more service requests. For example, the summary portion 730 includes details of the one or more service requests such as request ID, priority, SLA status, stage, requestor name, and the like. The dispatcher receives in-bound requests for legal services from the users such as clients or colleagues that are populated in the summary portion 730. The summary portion 730 also includes links to each of the one or more service requests listed. The dispatcher reviews the summary portion 730 and assesses or refines services requests, determines actions and resources, such as people, products, and processes, that fulfill the requirements of the service request.

The dispatcher or the legal professional collectively referred to as the user, may select and click on a link corresponding to a specific service request in the summary portion 730 for reviewing complete details corresponding to the selected service request in the workflow interface 800, as illustrated later in FIG. 8. In an embodiment, the system 100 directs the user to an interface with a list view of one or more service requests (not shown), upon choosing the link corresponding to the service requests in the navigation panel 720. The list view of the one or more service requests includes a link for each of the listed service requests and the system 100 directs the user to the workflow interface 800, upon receiving a click on the link. In an embodiment, the workflow dashboard 700 includes a launchpad portion (not shown) comprising one or more links to internal applications or third-party applications that support ease of access to the applications.

In an embodiment, the workflow dashboard 700 is configured to manage diverse legal projects that the system 100 supports. The diverse legal projects may include at least one project from a first legal discipline and at least one legal project from a second legal discipline. For example, the first legal discipline is intellectual property, and the second legal discipline is litigation. In an embodiment, the workflow dashboard 700 is populated with data stored in the database 206 or the data lake 306, illustrated in FIGS. 2 and 3, respectively and the workflow dashboard 700 is configured to track progress towards completing the tasks.

FIG. 8 illustrates the workflow interface 800 rendered by the system 100 to one or more individuals such as the dispatcher, the legal professionals, and the like, collectively referred to as the users. The workflow interface 800 includes a global ribbon bar 802, an interface management bar 810, a navigation panel 822, service request process flow portion 824, and a tabs portion 830. The global ribbon bar 802 includes features and functions similar to the global ribbon bar 702 of the workflow dashboard 700. The functionality of a search icon 804 is similar to the search icon 704, a notification icon 806 is similar to the notification icon 706, and a user profile icon 808 is similar to the user profile icon 708.

The interface management bar 810 includes interface elements related to actions affecting the service request such as save 812, assign service request 814, complete 816, cancel 818, and refresh 820. The interface management bar 810 is customized based on the user viewing the workflow interface 800. The navigation panel 822 includes features and functions similar to the navigation panel 720 of the workflow dashboard 700. Based on the designation of the user, the system 100 customizes the workflow interface 800.

The service request process flow portion 824, also referred to as process flow portion 824, includes a legal project information panel 826 that comprises one or more details corresponding to the legal project. The legal project information panel 826 displays a title of the legal project, current status of the legal project, and an identifier corresponding to the legal project. The process flow portion 824 further includes a service request status indicator 828, also referred to as a status indicator 828, which displays predefined milestones corresponding to the legal project. Also, the status indicator 828 indicates real-time status corresponding to the service requests to the users. For example, the status indicator 828 includes milestones such as submitted, triage, assigned, active, and completed; and highlights the current status of the legal project. Therefore, the status indicator 828 provides an indicator in form of a timeline to view the progress of the service request from receiving the service request until completion. The system 100 determines the progress of the service request i.e., the completion or achievement of the predefined milestones, based on one or more tasks performed towards creation of the legal work product or completion of the service request. For example, the one or more tasks related to the active milestone include writing a legal brief or a contract, revision of one or more documents related to the legal work product, or the like.

The timeline is updated, either manually or automatically, as and when a milestone is achieved, thereby provisioning the real-time status corresponding to each service request. Upon receiving an interactive input on the milestones displayed on the status indicator 828, the system 100 provides, for example, a pop-up interface displaying details of the assignor or the assignee, based on the designation of the user, that is the dispatcher or the legal professional, and date and time of the assignment.

The tabs portion 830 includes a details tab 832, a messages tab 834, a task tab 836, an impact and risk tab 838, and a time entries tab 840. The details tab 832 includes a detailed service request portion 842 that comprises information corresponding to the service request for the user to review. The information in the detailed service request portion 842 includes at least a description of the service request, requestor details of the service request, attachments related to the service request, timing corresponding to the service request, service catalog, and the like. The information in the detailed service request portion 842 is populated based on the input received from the client through the project creation user interface 600, as illustrated in FIG. 6. The workflow interface 800 that is customized for the legal professional allows the legal professional to modify the details of the service request that is displayed on the detailed service request portion 842.

The dispatcher reviews or parses the legal project information displayed in the detailed service request portion 842 and determines a relevant team or the legal discipline or a legal professional to work on the legal project. In an example, the parsing of the legal project information along with the determination of at least one of the legal disciplines or the legal professional is referred to as triaging. The dispatcher assigns the legal project to the determined team or the legal professional for working on or completing the legal project based on one or more features. For example, the one or more features include at least resource capacity based on type and nature of work, source of request, and facts associated with the user requesting service, and the like.

The dispatcher assigns the service request by interacting with the assign service request (SR) 814 interface element of the interface management bar 810. Upon interacting with the assign SR 814 interface element, the system 100 provides another interface (not shown) that allows the dispatcher to enter information corresponding to a relevant team or a legal professional to whom the legal project or the legal project would be assigned. The name of the team or the legal professional to whom the service request is assigned, by the dispatcher, is displayed on the workflow interface 800. For example, upon assigning the legal project to the relevant team or the legal professional by the dispatcher, the status indicator 828 automatically indicates a change in the status of the legal project as assigned. In an embodiment, the dispatcher can manually modify the status displayed on the status indicator 828.

In an embodiment, the triaging may not involve human intervention from the dispatcher and would be automated. The system 100 parses the received service request to extract data from one or more fields of the received service request and determines a corresponding legal discipline based on the parsed data. The parsing of the received service request to extract data from the one or more fields of the received service request and determination of the legal discipline and the project type is performed using at least one of the supervised learning and the unsupervised learning. The service request may be routed or assigned based on mapping or artificial intelligence or machine learning. The system 100 can further identify a sub-group in the determined legal discipline based on the parsed data and a predefined set of parameters of the sub-group. The sub-group may be a team or one or more professionals within the determined legal discipline. The predefined set of parameters includes resource capacity, background of professionals in the sub-group, geography of the professionals in the sub-group, and experience of the professionals. The system 100 assigns the legal project or the received service request to the determined legal discipline or the sub-group of the legal discipline. The triaging also supports in predictive decision-making related to negotiation intelligence, artificial intelligence assisted response, predictive modeling of business impact of future corporate activities, and the like.

Further, the interface management bar 810 is customized for the legal professional to comprise interface elements (not shown) such as cancel, create child case, delete, accept, reject, refresh, share, and the like. The accept and reject interface elements allow the legal professional to accept or reject the legal project or the service request assigned, respectively. Upon receiving a reject input from the assigned team or the legal professional, the system 100 notifies the dispatcher and reverts the assigned service request to the dispatcher. The notification is accessible to the dispatcher by interacting with a notification icon 806 of the global ribbon bar 802. Upon receiving an acceptance from the assigned team or the legal professional, the workflow interface 800 updates the status indicator 828 to indicate the status as active. Both the dispatcher and the assigned team or legal professional can view respective customized workflow interface 800 with the updated status indicator 828.

The messages tab 834 allows the dispatcher or the legal professional to send a message to one or more recipients associated with the legal project. The one or more recipients can be internal or external to the organization. The message sent through the messages tab 834 of the workflow interface 800 is displayed at least in the workspace interface 400 illustrated in FIG. 4 of the recipient. In an embodiment, the messages sent through the messages tab 834 of the workflow interface 800 are provided to external communication platforms, such as Slack® delivery channel, an SMS delivery channel, an email delivery channel, Microsoft® Teams® messaging delivery channel, and other communication channels, of the one or more recipients. The tasks tab 836 is automatically populated with tasks associated with milestones of the legal project. The tasks tab 836 allows the dispatcher or the legal professional to further split the legal project into multiple tasks and assign each of the multiple tasks to one or more legal professionals or teams of the organization.

In an embodiment, the workflow interface 800 supports the dispatcher or the legal professional to raise an impact and risk service request through the impact and risk tab 838. The dispatcher or the legal professional can identify a risk or any issue that impacts at least fulfillment or task completion of the service request and provide the information corresponding to the risk or the issue through the impact and risk tab 838. Upon receiving information through the impact and risk tab 838, the system 100 notifies one or more legal professionals such as managers, consultants, and the like, regarding the information received. The system 100 notifies through at least one of the one or more interfaces corresponding to the platform 102 or generic modes of communication, such as emails, text messages, and the like.

Further, the time entries tab 840 allows the user to add time entries corresponding to the service request or the legal project. In an embodiment, the time entries tab 840 displays the time spent by the legal professional corresponding to the legal project, that the system 100 tracks. The information in the time entries tab 840 is visible to one or more legal professionals based on the designation or association with the legal project.

The workflow interface 800 is communicatively coupled to the data lake 306, disclosed in FIG. 3, or the database 206, illustrated in FIG. 2, for collecting or providing data related to the legal project. The system 100 records each action, such as the assignment of the tasks or the service request, performed through the workflow interface 800, in the relational table in the data lake 306 or the database 206. The relational table is configured specifically for the legal project based on the legal discipline and the project type. The data lake 306 is configured to support projects in a plurality of legal disciplines or project types. Further, the workflow interface 800 is configured to link an integrated legal work application for tracking the performance of the one or more tasks, and the integrated work application is configured to report data to the data lake 306. In an embodiment, the workflow dashboard 700, illustrated in FIG. 7 and/or workflow interface 800 provides information, such as status, timeline, and milestones, of a project or one or more tasks corresponding to the service request that is executed in one or more different work applications. The workflow interface 800 is configured to provide data to the data lake 306 and to retrieve data from the data lake 306, thereby allowing the display of the status of the service request or the legal project in real-time.

In an embodiment, the workflow interface 800 is configured to manage diverse legal projects that the system 100 supports. The diverse legal projects may include at least one project from a first legal discipline and at least one legal project from a second legal discipline. For example, the first legal discipline is intellectual property, and the second legal discipline is litigation. In an embodiment, the workflow interface 800 is populated with data stored in the database 206 or the data lake 306, illustrated in FIGS. 2 and 3, respectively. In an embodiment, the system 100 provides an interface associated with the workflow interface 800 to track progress towards completing the tasks.

FIGS. 9A and 9B illustrate the reporting interface 900 for providing visualizations corresponding to diverse legal projects. The system 100 prepares and displays reports pertaining to multiple diverse legal projects. In an embodiment, the reporting interface 900 is configured to provide and display an aggregated report that provides an aggregation of metrics that are common across multiple projects of one or more legal disciplines or departments of the organization. The reporting interface 900 includes a link panel 902 with links and corresponding functionality similar to the link panel 402, illustrated in FIG. 4. A first link 904 and a second link 906 have a functionality similar to the first link 404 and the second link 406, respectively, illustrated in FIG. 4. A third link 908 and a username information portion 910 have a functionality similar to the third link 408 and the username information portion 410, respectively, illustrated in FIG. 4. For the sake of brevity, each of the elements 904, 906, 908, and 910 included in the link panel 902 are not described again. Further, the reporting interface 900 includes a download element 912 for downloading existing contents of the reporting interface 900 and a sharing element 914 for sharing the existing contents of the reporting interface 900 to a recipient through one or more communication channels such as, but not limited to, email, messages through third party applications, and the like.

The reporting interface 900 includes one or more modules that correspond with the diverse legal projects that the platform 102 handles for the client organization or the client system 110. The information provided by the one or more modules of the reporting interface 900 may or may not be identical for each user of the platform 102. The term “user” refers to individuals or organizations that use the platform 102. In an example, the user is the client or the client organization that uses the platform 102 for requesting services and viewing statuses related to one or more service requests or viewing statistics corresponding to different aspects or attributes of one or more legal projects. The user can also refer to one or more professionals employed by or associated with the organization.

The reporting interface 900 is customizable based on designation of the user intending to access the reporting interface 900 and/or a practice area or corresponding department of the user. The reporting interface 900 is further customizable based on the preferences of the user. To achieve the customization, a settings element 916 allows the user to customize the reporting interface 900 by selecting one or more modules that the user prefers to view. In such a manner, the user has the freedom to redesign the reporting interface 900 as per the user's preference(s). A timing element 918 allows the user to select a time period for which the reporting interface 900 displays the data corresponding to the selected one or more modules. A module selection element 920 allows the user to choose one or more modules of the selected one or more modules. For example, the user selects an option to display all the selected one or more modules through the module selection element 920.

The one or more modules of the reporting interface 900 include a transaction status module 922 that provides information related to the statuses of the one or more service requests. The transaction status module 922 provides a first layer of information 924 corresponding to different stages of the service requests. For example, the first layer of information 924 includes but is not limited to the number of service requests that are under a new and assigned stage, in a created and reviewed stage, in a negotiations and approvals stage, and in a completed stage. The first layer of information 924 also includes a first sublayer of information 926 corresponding to a percentage of change of the first layer of information 924 over a predetermined time period.

The transaction status module 922 provides a second layer of information 928 for each stage. For example, the second layer of information 928 for the new and assigned stage includes information corresponding to a number of service requests that are unassigned, assigned, urgent, with service level agreement (SLA) overdue and aging, and average days assigned. Similarly, for the negotiations and approvals stage, the second layer of information 928 includes a number of service requests that are expected to close, that are to be escalated, and the like. At least one of the first layer of information 924 and the second layer of information 928 includes clickable links that direct the user to one of a new interface, a pop-up interface, or another portion in the reporting interface 900 to display further details corresponding to the clicked link. It will be apparent to one with ordinary skill in the art that the second layer of information 928 may include any number of elements that are related to the main element of the first layer of information 924 and the examples provided above are non-limiting.

The transactions status module 922 further provides visualizations 930 corresponding to one or more attributes of the one or more service requests. For example, the visualizations 930 include graphs that provide information related to the second layer of information 928 against business units of the client organization. For example, a bar in a bar graph indicates at least one of the portions of the second layer of information 928, related to one or more business units related to the client organization. The second layer of information 928, in an embodiment, includes a number of service requests that are assigned, unassigned, urgent, SLA overdue, and SLA aging for the service requests. In an example, a business unit 1 corresponds with additive manufacturing, a business unit 2 corresponds with business and general aviation. Further, a business unit 3 corresponds with a commercial engine, a business unit 4 corresponds with helicopters, a business unit 5 corresponds with military systems, and a business unit 6 corresponds with aviation systems. It will be apparent to a person with ordinary skill in the art that the visualizations 930 may include pie charts, line graphs, histogram charts, scatter plots, or the like, for representing one or more attributes of the one or more service requests.

FIG. 9B illustrates the reporting interface 900 with other modules such as a utilization module 932 that provides visualizations 938 corresponding to work capacity by one or more resource levels. The utilization module 932 provides information at least regarding different levels of resources and the capacity of each of the resource levels as a percentage. The utilization module 932 includes a time filter 934 that allows the user to filter the utilization information based on one or more time-related parameters, such as a current month, a current year, a current quarter, and the like, based on which the visualizations 938 are modified. It will be apparent to a person with ordinary skill in the art that the visualizations 938 may include pie charts, line graphs, histogram charts, scatter plots, or the like, for representing the work capacity. Further, the utilization module 932 includes a resource level filter 936 that allows the user to select the resource levels for which the user prefers to view the capacity percentages.

Further, the reporting interface 900 includes a top impact module 940 that provides information related to business units with projects of higher impact. The top impact module 940 provides a summary portion 944 comprising summarized information such as a status, business unit, request ID, and date of the request for each of the projects with higher impact. The top impact module 940, therefore, provides the summarized information of the higher impact projects readily to a user, and accordingly the user utilizes the summarized information to expedite the completion of one or more requests appearing under the top impact module 940. The top impact module 940 further includes a status filter 942 for displaying summarized information in the summary portion 944 based on the status of the projects of the business units.

The reporting interface 900 also provides a service request region module 946 with a time filter 948, a filter 950, a visualization portion 952, and a summary portion 954. The time filter 948 allows the user to filter at least one of the summary portion 954 and the visualization portion 952 information based on one or more time-related parameters, such as a current month, a current year, a current quarter, and the like. Further, a filter 950 of the service request region module 946 allows the user to modify the visualization portion 952.

The visualization portion 952 displays the volume of service requests across different regions over a map. In an embodiment, the user may interact with the map in the visualization portion 952 to zoom in or zoom out regions of the map and display the volume of service requests in the zoomed in or out regions in the map. The summary portion 954 provides region-wise information corresponding to different attributes of the service requests. For example, the summary portion 954 provides information regarding a number of service requests that are unassigned, urgent, aging as per service level agreement (SLA), and the like. The summary portion 954 also provides information regarding the number of service requests that are new, active, and closed. Further, the summary portion 954 provides information related to the number of service requests that each department, of the client organization, handles. For example, as illustrated in FIG. 9B, the commercial department is currently working on 27 service requests, the corporate department is currently working on 19 service requests, the litigation department is currently working on 6 service requests and the like. The reporting interface 900 further includes other modules (not shown) such as operations, commercial transactions, intellectual property, risk and compliance, and the like.

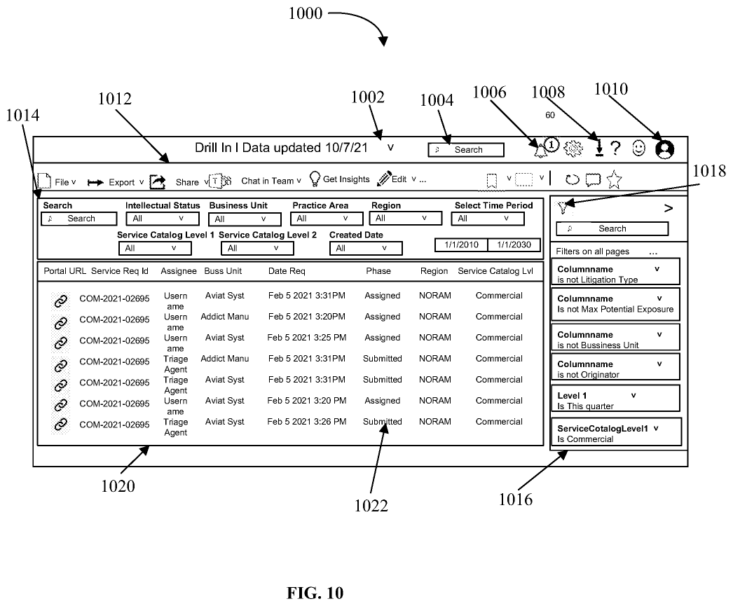

FIG. 10 illustrates a drill-in interface 1000 for providing a summary 1022 of the service requests to the user. The second layer of information 928 of the transaction status module 922 includes links, which when interacted with, causes the reporting interface 900 to provide the drill-in interface 1000. The drill-in interface 1000 includes a global ribbon bar 1002, which further includes a search icon 1004 that allows the user to search at least a service request, users, team, and the like, and a notifications icon 1006 that indicates the presence of one or more notifications to the user and allows the user to access the one or more notifications. Further, the global ribbon bar 1002 includes a download icon 1008 that allows the user to download current contents of the drill-in interface 1000 and a profile icon 1010 that displays user credentials, such as username, designation, and the like. In an embodiment, the profile icon 1010 also displays special viewing permissions provided to the user.

The drill-in interface 1000 further includes a toolbar portion 1012 that comprises a variety of icons that act as tools for the user. As non-limiting examples illustrated in FIG. 10, the toolbar portion 1012 includes at least a file icon that allows the user to perform functions such as printing, saving, and the like. The toolbar portion 1012 also includes an export icon to export the view of the drill-in interface 1000 in a PDF, Excel, and other supported formats; and a share icon for sharing the current view of the drill-in interface 1000 with one or more recipients. The toolbar portion 1012 further comprises a chat icon that allows the user to communicate in real-time with one or more recipients through a third-party application.

Further, the drill-in interface 1000 includes a summary search portion 1014, a filter portion 1016, a filter element 1018, and a summary portion 1020. The summary search portion 1014 allows the user to search the summary portion 1020 based on at least business unit, region, time period, and the like. The filter portion 1016 allows the user to filter the summary portion 1020 based on time period, the service catalog level 1, the service catalog level 2, and the like, using a filter element 1018. The filter portion 1016 also displays a list of filters applied to the summary portion 1020 of the drill-in interface 1000.

The summary 1022 of the service requests in the drill-in interface 1000 is presented in the summary portion 1020 that includes at least information such as service request ID, assignee, business unit, date requested, phase, region, service catalog level 1, service catalog level 2, and SLA title, and the like. For example, a user clicks on the link corresponding to assigned service requests in the first layer of information 924, that is, new and assigned, of the transaction status module 922, illustrated in FIG. 9. As a result of the user click, the drill-in interface 1000 displays a list of the service requests that are new and assigned across diverse legal disciplines or departments of the organization. Each line item of the list includes information such as the service request ID, the assignee, the business unit, the date requested, the phase, the region, the service catalog level 1, the service catalog level 2, the SLA title, and the like, corresponding to the assigned service request. The drill-in interface 1000, therefore, provides the summary 1022 as a third layer of information corresponding to the service requests.

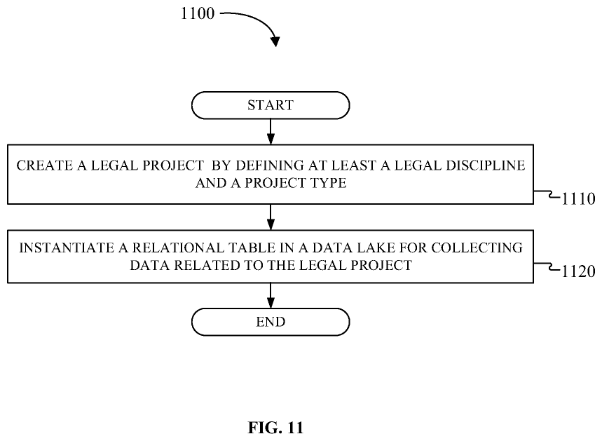

FIG. 11 illustrates an example method 1100 for creating diverse legal projects in an enterprise legal platform. Although the example method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence.

According to some embodiments, the method 1100 includes creating a legal project in the enterprise legal platform by defining at least a legal discipline and a project type at block 1110. The enterprise legal platform, in an embodiment, is the platform 102 illustrated in FIG. 1. For example, the client system 110 illustrated in FIG. 1 creates a legal project in the platform 102. The project creation user interface 600, illustrated in FIG. 6, is accessible to the client system 110, illustrated in FIG. 1, for creating the legal project. The project creation user interface 600 is the structured form including the plurality of fields that define at least the legal discipline and the project type. A subset of the plurality of fields has a dependency relationship. An option chosen in a first of the subset of the plurality of fields can cause fields in a second of the subset of the plurality of fields to dynamically populate with options that are dependent on the option chosen in the first of subset of fields. The project creation user interface 600 is configured to receive data defining the legal project by the legal discipline and the project type through one or more fields of the plurality of fields.

The method 1100 further includes instantiating a relational table in the data lake 306, disclosed in FIG. 3, for collecting data related to the legal project at block 1120. For example, the platform 102, illustrated in FIG. 1 instantiates a relational table in the data lake 306 for collecting data related to the legal project. The relational table is configured specifically for the legal project based on the legal discipline and the project type. The data lake 306 is configured to support projects in a plurality of legal disciplines or project types. The relational table instantiated upon the creation of the legal project in the project creation user interface, is configured specifically for the legal project based on the options chosen in the plurality of the fields of the project creation user interface.

An enterprise system of the client, that is, the client system 110, illustrated in FIG. 1, is utilized by a user or a client for creating the legal project. The enterprise system of the client, that is the client system 110, is integrated into the data lake 306 using an integration layer, such as the integration layer 208 illustrated in FIG. 2, that is configured to receive data from the client system 110. The client system 110 is separate from the enterprise legal platform, that is the platform 102, illustrated in FIG. 1. The legal project created is associated with a plurality of project milestones which is dependent on or predefined based on the legal discipline and the project type. The relational table is configured specifically for the legal project by including data structures to track progress toward the project milestones.

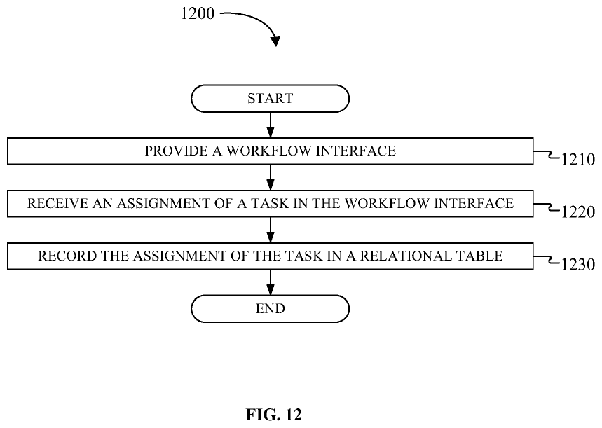

FIG. 12 illustrates an example method 1200 for managing diverse legal projects in the enterprise legal platform, that is the platform 102, illustrated in FIG. 1. Although the example method 1200 depicts a particular sequence of operations, the sequence may be altered without departing from the scope of the present disclosure. For example, some of the operations depicted may be performed in parallel or in a different sequence that does not materially affect the function of the method 1200. In other examples, different components of an example device or system that implements the method 1200 may perform functions at substantially the same time or in a specific sequence.

According to some embodiments, the method 1200 includes providing at least one interface such as the workflow interface 800, illustrated in FIG. 8, that is configured to manage diverse legal projects at block 1210. For example, the platform 102, illustrated in FIG. 1, may provide the workflow interface 800, which is configured to manage the diverse legal projects. The diverse legal projects include at least one project from a first legal discipline and at least one legal project from a second legal discipline. In an embodiment, the diverse legal projects that the workflow interface 800 manages, may be provided by the enterprise system of the client, that is the client system 110, illustrated in FIG. 1, through the project creation user interface 600, illustrated in FIG. 6. In an embodiment, the diverse legal projects that the workflow interface 800 manages may be provided through an email mode of communication or and through a voice mode of communication.

The workflow interface 800 is automatically populated with tasks associated with milestones of the legal project which are predefined based on the legal discipline and the project type. The workflow interface 800 is configured to link to an integrated legal work application for the performance of the task. The workflow interface 800 is further configured to provide an interface to track progress towards completion of the tasks.

The method 1200 further includes receiving an assignment of a task associated with the legal project in the workflow interface 800, at block 1220, from a user such as a dispatcher, as disclosed in the detailed description of FIG. 8 or a legal professional. The workflow interface 800 is also configured to permit acceptance of one or more assigned tasks associated with the legal project.

The diverse legal projects include at least one project from a first legal discipline and at least one legal project from a second legal discipline. The workflow interface 800 is configured to permit the acceptance of assigned tasks associated with the legal project.

The method 1200 further includes recording the assignment in the relational table in the data lake 306, disclosed in FIG. 3, for collecting data related to the legal project at block 1230. The relational table is configured specifically for the legal project based on a legal discipline and a project type. The data lake 306 is configured to support projects in the plurality of legal disciplines or project types. The integrated legal work application is configured to report data to the data lake 306. The interface to track details of progress towards completion of the tasks is populated with data stored in the data lake 306. The workflow interface 800 is configured to manage any type of legal project supported by the system 100 or the enterprise legal platform, that is the platform 102 illustrated in FIG. 1, for managing data for diverse legal projects. Further, the workflow interface 800 is configured to provide data to the data lake 306 and to retrieve data from the data lake 306.

In an embodiment, the method 1200 provides at least one interface that is configured to manage diverse legal projects at block 1210, block 1220, and block 1230. The at least one interface includes interfaces such as the workflow dashboard 700, illustrated in FIG. 7.

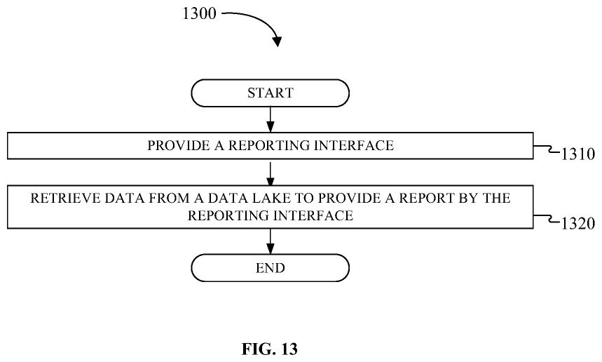

FIG. 13 illustrates an example method 1300 for reporting data from a plurality of diverse legal projects. Although the example method 1300 depicts a particular sequence of operations, the sequence may be altered without departing from the scope of the present disclosure. For example, some of the operations depicted may be performed in parallel or in a different sequence that does not materially affect the function of the method 1300. In other examples, different components of an example device or system that implement the method 1300 may perform functions at substantially the same time or in a specific sequence.

According to some embodiments, the method 1300 includes providing the reporting interface 900 at block 1310. For example, the platform 102 illustrated in FIG. 1 may provide the reporting interface 900. The reporting interface 900 is configured to prepare and display reports pertaining to the plurality of diverse legal projects. The reporting interface 900 is configured to provide an aggregated report that provides an aggregation of metrics that are common across the plurality of diverse legal projects. Further, the reporting interface 900 is configured to provide an aggregated report that provides an aggregation of metrics across a plurality of projects in the legal discipline. The aggregation of metrics common across the plurality of diverse legal projects and a plurality of projects in the legal discipline is displayed in the reporting interface 900 through one or more modules and multiple layers of information, such as the first layer of information 924, the first sublayer of information 926, and the second layer of information 928.

The method 1300 further includes retrieving data from the data lake 306, as previously described in FIG. 3, to provide a report by the reporting interface 900 at block 1320. The data lake 306 is configured to store the unstructured data and the structured data. The structured data is in the form of relational tables specifically configured for a particular legal project from the plurality of diverse legal projects. The particular legal project is characterized by one of a plurality of legal disciplines and project types. The unstructured data is the form of documents such as the legal work products associated with the legal project.

For example, a client wants an existing contract to be amended with different terms and conditions. The client prefers to offer work corresponding to the amendment of the existing contract to legal professionals of a litigation team. The client accesses the platform 102 through the SSO and is directed to the workspace interface 400. To create a service request, the client accesses the service request interface 500 and interacts with the service request button 512, which is illustrated in FIG. 5. Upon receiving input on the service request button 512 by the client in form of a click, the platform 102 provides the project creation user interface 600, illustrated in FIG. 6, to the client. The project creation user interface 600 is the structured form with a plurality of fields provided based on a service catalog that corresponds with a generic set of fields common across service requests with different legal disciplines and project types.

The client provides inputs to the service category fields 620 such as the service request type field 622 as “Litigation”, which are illustrated in FIG. 6. Upon receiving the input, the system 100 considers a service catalog corresponding to Litigation legal discipline and populates options for the sub type field 624, illustrated in FIG. 6. The client provides inputs to the plurality of fields of the project creation user interface 600 and describes nuances of the service request. The client mentions that every instance of days corresponding to any mentioned service in the contract has to be increased by five more days. Further, the time associated with document review service should be restored to a time present in the originally executed contract. Upon providing the inputs, the client submits the service request form for creating the service request or a legal project.

The system 100 instantiates a new relational table in the data lake 306, disclosed in FIG. 3, upon receiving the submission of the service request or the creation of the legal project. The new relational table is configured for the chosen legal discipline i.e., Litigation, and the project type i.e., amendment of the existing contract. The new relational table is further configured specifically for the legal project based on the legal discipline, the project type, and the inputs to the plurality of fields of the service request form. Each legal project has milestones that are predefined based on the legal discipline and the project type. Further, the new relational tables are also configured to track progress towards milestones of the legal project.

The system 100, upon creating the legal project, directs the service request form to a user, such as a dispatcher. The dispatcher assigns the legal project to a relevant team, that is a Litigation department, through the workflow interface 800, illustrated in FIG. 8, that is customized for the dispatcher. A legal professional associated with the Litigation department accepts the service request and further divides work related to the received service request into multiple fragments of work through the workflow interface 800 customized for the legal professional.

Each fragment of work is provided to a legal professional of the Litigation department. Each fragment of work includes, for example, reviewing at least 100 pages of the existing contract of 1000 pages and identifying and modifying as per the inputs of the client. Each legal professional accesses a recent version of the existing contract. The recent version of the existing contract includes preset snapshots of data fields or portions with recent amendments to the contract. Each legal professional of the Litigation team makes necessary modifications as per the inputs from the client and the system 100 takes preset snapshots of the amendments made to the existing contract and stores in the data lake 306. A legal professional, assigned with the fragment of work with the patent drafting service clause, accesses the originally executed contract stored in the data lake 306 to review the time allocated. Based on the time mentioned in the originally executed contract, the legal professional modifies the clause that discloses the time related to the patent drafting service, in the recent version of the originally executed contract. The amendments to the recent versions of the contract do not affect the originally executed contract as that remains as a read-only copy. The snapshots of amendments, in an embodiment, are obtained by the system 100 at different times.

The system 100 collects and integrates each snapshot of the amendments to the recent versions of the contract to provide a new version of the originally executed contract with the most recent amendments as per the legal project, irrespective of the time the system 100 takes to obtain the snapshots. The system 100 then provides the new version of the originally executed contract to another legal professional such as a manager. In an embodiment, the manager and each of the legal professionals may be located in different regions of the world. The manager reviews the new version of the originally executed contract and is allowed to make further amendments to the new version of the originally executed contract. The system 100 then snapshots the amendments from the manager to create the next version of the originally executed contract. The next version of the originally executed contract comprises the amendment from the manager and the other portions of the new version of the originally executed contract that did not include any amendments from the manager.

Subsequently, the system 100 stores the new version of the originally executed contract and also the next version the data lake 306. This allows the manager or the legal professional to review and track differences between various versions of the originally executed contract. The system 100 tracks work performed by each of the legal professional and stores corresponding data in the relational tables of the data lake 306. Based on the tracked work, the system 100 updates the status of the legal project in at least the status indicator 828 of the workflow interface 800, illustrated in FIG. 8. The system 100 allows the client to access the workflow interface 800 that is customized for the client and displays the real-time status of the legal project through the status indicator 828. Further, each legal professional, including the manager, accesses the workflow interface 800 that is customized based on the respective designations. However, the status indicator 828 in the customized workflow interface 800 for the legal professionals and the client are synchronized.

The system 100 then parses the data in the next version of the originally executed contract and provides that parsed data to the reporting interface 900 of the insights system 108, illustrated in FIG. 9. The insights system 108 of the system 100 then prepares data for creating virtual representations in the reporting interface 900. For example, the system 100 obtains data related to the time corresponding to each service in the SLA and provides a visual representation such as a pie chart, to depict the time allotted for each service. The system 100 allows the client to access the reporting interface 900 to understand the outcome of the project.

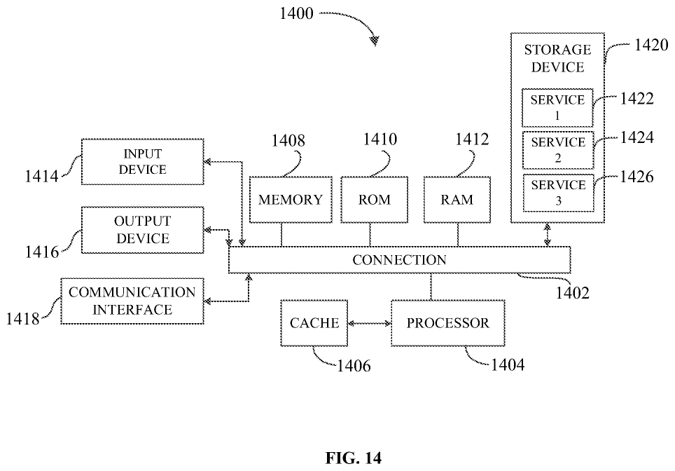

FIG. 14 shows an example of a computing system 1400, which can be, for example, any computing device that is part of the system 100 which is communicatively coupled to the client system 110 or any component thereof in which the components of the system 100 are in communication with each other using a connection 1402. The connection 1402 can be a physical connection via a bus, or a direct connection into a processor 1404, such as in a chipset architecture. The connection 1402 can also be a virtual connection, a networked connection, or a logical connection.

In some embodiments, the computing system 1400 is a distributed system in which the functions described in this disclosure can be distributed within a datacenter, multiple data centers, a peer network, and the like. In some embodiments, one or more of the described system components represents many such components each performing some or all of the functions for which the component is described. In some embodiments, the components can be physical or virtual devices.

The example computing system 1400 includes at least one processor (central processing unit (CPU) or processing unit) 1404, and the connection 1402 couples various system components including system memory 1408, such as read-only memory (ROM) 1410 and random-access memory (RAM) 1412 to the processor 1404. The computing system 1400 can include a cache 1406 of high-speed memory connected directly with, in close proximity to, or integrated as part of the processor 1404.

The processor 1404 can include any general-purpose processor and a hardware service or software service, such as services 1422, 1424, and 1426 stored in storage device 1420. The services 1422, 1424, and 1426 are configured to control the processor 1404 as well as a special-purpose processor where software instructions are incorporated into the actual processor design. The services 1422, 1424, and 1426 may be equivalent to the primary portal 104, the legalflow system 106, and insights system 108, illustrated in FIG. 1 respectively. The processor 1404 may essentially be a completely self-contained computing system, containing multiple cores or processors, a bus, memory controller, cache, and the like. A multi-core processor may be symmetric or asymmetric.

To enable user interaction, the computing system 1400 includes an input device 1414, which can represent any number of input mechanisms, such as a microphone for speech, a touch-sensitive screen for gesture or graphical input, keyboard, mouse, motion input, speech, and the like. The computing system 1400 can also include an output device 1416, which can be one or more of a number of output mechanisms known to those of skill in the art. In some instances, multimodal systems can enable a user to provide multiple types of input/output to communicate with computing system 1400. The computing system 1400 can include a communication interface 1418, which can generally govern and manage the user input and system output. There is no operational restriction on any particular hardware arrangement, and therefore the basic features here may easily be substituted for improved hardware or firmware arrangements as they are developed.

The storage device 1420 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices. The storage device 1420 can include software services, servers, services, and the like, that when the code that defines such software is executed by the processor 1404, it causes the computing system 1400 to perform a function. In some embodiments, a hardware service that performs a particular function can include the software component stored in a computer-readable medium in connection with the necessary hardware components, such as the processor 1404, the connection 1402, the output device 1416, and the like, to carry out the function. The storage device 1420, in an embodiment, includes the database 206, illustrated in FIG. 2. In an embodiment, the storage device 1420 includes the database 306 of the insights system 108, that is the data lake 306, illustrated in FIG. 3. In an embodiment, the storage device 1420 is wirelessly coupled to the database 206 or the database 306 of the insights system 108 for communication.

For sake of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of the system 100 or the computing system 1400 and performs one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A system for managing data for diverse legal projects, the system comprising: a project creation user interface, the project creation user interface configured to receive data defining a legal project by a legal discipline and a project type; and a data lake, the data lake configured to store unstructured data and structured data, the structured data being in the form of relational tables specifically configured for a respective one of a plurality of legal disciplines and project types, wherein a new relational table can be instantiated upon creation of the legal project in the project creation user interface, wherein the relational table is configured specifically for the legal project based on the legal discipline and the project type, the unstructured data being in the form of documents associated with the legal project.

Aspect 2: The system of Aspect 1, wherein the relational tables are configured to track progress towards milestones of the legal project.

Aspect 3: The system of any of Aspects 1 to 2, wherein the milestones of the legal project are predefined based on the legal discipline and the project type.

Aspect 4: The system of any of Aspects 1 to 3, wherein the project creation interface is a structured form comprising a plurality of fields including fields defining the legal discipline and the project type, a subset of the plurality of fields has a dependency relationship, and wherein an option chosen in a first of the subset of the plurality of fields can cause fields in a second of the subset of the plurality of fields to dynamically populate with options that are dependent on the option chosen in the first of subset of fields.

Aspect 5: The system of any of Aspects 1 to 4, wherein the relational table instantiated upon creation of the legal project in the project creation user interface, is configured specifically for the legal project based on the options chosen in the plurality of the fields.

Aspect 6: The system of any of Aspects 1 to 5, further comprising: a workflow interface, the workflow interface is configured to allow the assignment of tasks associated with the legal project and to permit acceptance of assigned tasks associated with the legal project.

Aspect 7: The system of any of Aspects 1 to 6, wherein the workflow interface is automatically populated with tasks associated with milestones of the legal project, and wherein the milestones of the legal project are predefined based on the legal discipline and the project type.

Aspect 8: The system of any of Aspects 1 to 7, wherein the workflow interface is configured to provide an interface to track progress towards completing the tasks.

Aspect 9: The system of any of Aspects 1 to 8, wherein the interface to track details of progress towards completion of the tasks is populated with data stored in the data lake.

Aspect 10: The system of any of Aspects 1 to 9, wherein the workflow interface is configured to link to an integrated legal work application for the performance of the task.

Aspect 11: The system of any of Aspects 1 to 10, wherein the integrated legal work application is configured to report data to the data lake.

Aspect 12: The system of any of Aspects 1 to 11, wherein the workflow interface is configured to manage any type of legal project supported by the system for managing data for diverse legal projects, and the workflow interface is configured to provide data to the data lake and to retrieve data from the data lake.

Aspect 13: The system of any of Aspects 1 to 12, further comprising: a reporting interface, the reporting interface configured to pull data from the data lake to provide a report.

Aspect 14: The system of any of Aspects 1 to 13, wherein the reporting interface is configured to provide an aggregated report that provides an aggregation of metrics that are in common across a plurality of projects in a plurality of legal disciplines.

Aspect 15: The system of any of Aspects 1 to 14, wherein the reporting interface is configured to provide an aggregated report that provides an aggregation of metrics across a plurality of projects in a legal discipline.

Aspect 16: The system of any of Aspects 1 to 15, further comprising: an integration layer, the integration layer configured to receive data from an enterprise system of a client and to ingest the received data into the data lake.

Aspect 17: A method for creating diverse legal projects in an enterprise legal platform, the method comprising: creating a legal project in the enterprise legal platform by defining at least a legal discipline and a project type; and instantiating a relational table in a data lake for collecting data related to the legal project, wherein the relational table is configured specifically for the legal project based on the legal discipline and the project type, and wherein the data lake is configured to support projects in a plurality of legal disciplines or project types.

Aspect 18: The method of Aspect 17, wherein the creating the legal project is performed using a project creation user interface, the project creation user interface being configured to receive data defining the legal project by the legal discipline and the project type.

Aspect 19: The method of any of Aspects 17 to 18, wherein the project creation interface is a structured form including a plurality of fields including fields defining the legal discipline and the project type, a subset of the plurality of fields has a dependency relationship, and wherein an option chosen in a first of the subset of the plurality of fields can cause fields in a second of the subset of the plurality of fields to dynamically populate with options that are dependent on the option chosen in the first of subset of fields.

Aspect 20: The method of any of Aspects 17 to 19, wherein the relational table instantiated upon creation of the legal project in the project creation user interface, is configured specifically for the legal project based on the options chosen in the plurality of the fields.

Aspect 21: The method of any of Aspects 17 to 20, wherein the creating the legal project is performed using an enterprise system of a client that is integrated into the data lake using an integration layer that is configured to receive data from an enterprise system, wherein the enterprise system is separate from the enterprise legal platform.

Aspect 22: The method of any of Aspects 17 to 21, wherein the legal project is associated with a plurality of project milestones, the plurality of project milestones being dependent on the legal discipline and project type, and wherein the relational table is configured specifically for the legal project by including data structures to track progress toward the project milestones.

Aspect 23: A method for managing diverse legal projects in an enterprise legal platform, the method comprising: providing a workflow interface, the workflow interface is configured to manage diverse legal projects, wherein the diverse legal projects include at least one project from a first legal discipline and at least one legal project from a second legal discipline; receiving an assignment of a task associated with the legal project in the workflow interface; and recording the assignment in a relational table in a data lake for collecting data related to the legal project, wherein the relational table is configured specifically for the legal project based on a legal discipline and a project type, wherein the data lake is configured to support projects in a plurality of legal disciplines or project types.

Aspect 24: The method of Aspect 23, wherein the workflow interface is configured to permit acceptance of assigned tasks associated with the legal project.

Aspect 25: The method of any of Aspects 23 to 24, wherein the workflow interface is automatically populated with tasks associated with milestones of the legal project, wherein the milestones of the legal project are predefined based on the legal discipline and the project type.

Aspect 26: The method of any of Aspects 23 to 25, wherein the workflow interface is configured to provide an interface to track progress towards completion of the tasks.

Aspect 27: The method of any of Aspects 23 to 26, wherein the workflow interface is configured to link to an integrated legal work application for the performance of the task.

Aspect 28: The method of any of Aspects 23 to 27, wherein the integrated legal work application is configured to report data to the data lake.

Aspect 29: The method of any of Aspects 23 to 28, wherein the interface to track details of progress towards completion of the tasks is populated with data stored in the data lake.

Aspect 30: The method of any of Aspects 23 to 29, wherein the workflow interface is configured to manage any type of legal project supported by the system for managing data for diverse legal projects, and the workflow interface is configured to provide data to the data lake and to retrieve data from the data lake.

Aspect 31: A method for reporting on data from a plurality of diverse legal projects comprising: providing a reporting interface, wherein the reporting interface is configured to prepare and display reports pertaining to the plurality of diverse legal projects; retrieving data from a data lake to provide a report by the reporting interface, wherein the data lake, the data lake is configured to store unstructured data and structured data, the structured data being in the form of relational tables specifically configured for a particular legal project from the plurality of diverse legal projects, the particular legal project being characterized by one of a plurality of legal disciplines and project types, the unstructured data being in the form of documents associated with the legal project.

Aspect 32: The method of Aspect 31, wherein the reporting interface is configured to provide an aggregated report that provides an aggregation of metrics that are in common across the plurality of diverse legal projects.

What is claimed is:

1. A system for managing data for diverse legal projects, the system comprising:
a project creation user interface, the project creation user interface configured to receive data defining a legal project by a legal discipline and a project type; and
a data lake, the data lake configured to store unstructured data and structured data,
the structured data being in the form of relational tables specifically configured for a respective one of a plurality of legal disciplines and project types, wherein a new relational table can be instantiated upon creation of the legal project in the project creation user interface, and wherein the relational table is configured specifically for the legal project based on the legal discipline and the project type,
the unstructured data being in the form of documents associated with the legal project.

2. The system of claim 1, wherein the relational tables are configured to track progress towards milestones of the legal project.

3. The system of claim 2, wherein the milestones of the legal project are predefined based on the legal discipline and the project type.

4. The system of claim 1, wherein the project creation interface is a structured form comprising a plurality of fields including fields defining the legal discipline and the project type, a subset of the plurality of fields has a dependency relationship, and wherein an option chosen in a first of the subset of the plurality of fields causes fields in a second of the subset of the plurality of fields to dynamically populate with options that are dependent on the option chosen in the first of the subset of the plurality of fields.

5. The system of claim 4, wherein the relational table instantiated upon creation of the legal project in the project creation user interface, is configured specifically for the legal project based on the options chosen in the plurality of the fields.

6. The system of claim 1, further comprising:
a workflow interface, the workflow interface is configured to allow the assignment of tasks associated with the legal project and to permit acceptance of assigned tasks associated with the legal project.

7. The system of claim 6, wherein the workflow interface is automatically populated with tasks associated with milestones of the legal project, and wherein the milestones of the legal project are predefined based on the legal discipline and the project type.

8. The system of claim 7, wherein the workflow interface is configured to provide an interface to track progress towards completing the tasks.

9. The system of claim 7, wherein the workflow interface is configured to link to an integrated legal work application for the performance of the task.

10. The system of claim 9, wherein the integrated legal work application is configured to report data to the data lake.

11. The system of claim 8, wherein the interface to track details of progress towards completion of the tasks is populated with data stored in the data lake.

12. The system of claim 6, wherein the workflow interface is configured to manage any type of legal project supported by the system for managing data for diverse legal projects, and the workflow interface is configured to provide data to the data lake and to retrieve data from the data lake.

13. The system of claim 1, further comprising:
a reporting interface, the reporting interface configured to pull data from the data lake to provide a report.

14. The system of claim 13, wherein the reporting interface is configured to provide an aggregated report that provides an aggregation of metrics that are in common across a plurality of projects in a plurality of legal disciplines.

15. The system of claim 13, wherein the reporting interface is configured to provide an aggregated report that provides an aggregation of metrics across a plurality of projects in a legal discipline.

16. The system of claim 1, further comprising:
an integration layer, the integration layer configured to receive data from an enterprise system of a client and to ingest the received data into the data lake.

17. A method for creating diverse legal projects in an enterprise legal platform, the method comprising:
creating a legal project in the enterprise legal platform by defining at least a legal discipline and a project type; and
instantiating a relational table in a data lake for collecting data related to the legal project, wherein the relational table is configured specifically for the legal project based on the legal discipline and the project type, and wherein the data lake is configured to support projects in a plurality of legal disciplines or project types.

18. The method of claim 17, wherein the creating the legal project is performed using a project creation user interface, the project creation user interface being configured to receive data defining the legal project by the legal discipline and the project type.

19. The method of claim 17, wherein the project creation interface is a structured form including a plurality of fields including fields defining the legal discipline and the project type, a subset of the plurality of fields has a dependency relationship, and wherein an option chosen in a first of the subset of the plurality of fields can cause fields in a second of the subset of the plurality of fields to dynamically populate with options that are dependent on the option chosen in the first of subset of fields.

20. The method of claim 19, wherein the relational table instantiated upon creation of the legal project in the project creation user interface, is configured specifically for the legal project based on the options chosen in the plurality of the fields.

21. The method of claim 17, wherein the creating the legal project is performed using an enterprise system of a client that is integrated into the data lake using an integration layer that is configured to receive data from an enterprise system, and wherein the enterprise system is separate from the enterprise legal platform.

22. The method of claim 17, wherein the legal project is associated with a plurality of project milestones, the plurality of project milestones being dependent on the legal discipline and project type, and wherein the relational table is configured specifically for the legal project by including data structures to track progress toward the project milestones.
